(19) United States
(12) Patent Application Publication
(10) Pub. No.: US 2021/0353389 A1
(43) Pub. Date: Nov. 18, 2021

(54) DENTAL APPLIANCES AND ASSOCIATED SYSTEMS AND METHODS OF USE

(71) Applicant: Brius Technologies, Inc., Carrollton, TX (US)

(72) Inventors: Seyed Mehdi Roein Peikar, Addison, TX (US); James Sylvester Wratten, JR., Waterville, NY (US)

(21) Appl. No.: 17/302,227

(22) Filed: Apr. 27, 2021

Related U.S. Application Data
(60) Provisional application No. 62/704,545, filed on May 15, 2020.

(51) Int. Cl. A61C 7/14; A61C 7/16

(52) U.S. Cl. CPC A61C 7/146; A61C 7/16

(57) ABSTRACT

An orthodontic appliance and associated systems and methods are disclosed herein. In some embodiments, the appliance comprises a retainer configured to retain a patient's teeth in a desired final tooth arrangement. The retainer can include a plurality of attachment portions, each configured to be coupled to a securing member adhered to a tooth of the patient. When the retainer is positioned adjacent to the patient's teeth and secured to the securing members, a shape of the attachment portions can inhibit the attachment portions from translating and/or rotating relative to the securing member.

### CROSS REFERENCE TO RELATED APPLICATIONS

The present application claims the benefit of priority to PCT Application No. PCT/US20/70017, filed May 2, 2020, and U.S. Provisional Application No. 62/704,545, filed May 15, 2020, both of which are incorporated by reference herein in their entireties.

This present application is related to the following applications, each of which is hereby incorporated by reference in its entirety: U.S. patent application Ser. No. 16/865,323, titled DENTAL APPLIANCES, SYSTEMS AND METHODS, filed May 2, 2020; International Patent Application No. PCT/US20/31211, titled DENTAL APPLIANCES, SYSTEMS AND METHODS, filed May 2, 2020; U.S. patent application Ser. No. 15/929,443, titled DENTAL APPLIANCES AND ASSOCIATED SYSTEMS AND METHODS OF USE, filed May 2, 2020; U.S. patent application Ser. No. 15/929,444, titled DENTAL APPLIANCES AND ASSOCIATED SYSTEMS AND METHODS OF USE, filed May 2, 2020, U.S. Patent Application No. PCT/US20/70017, titled DENTAL APPLIANCES AND ASSOCIATED SYSTEMS AND METHODS OF USE, filed May 2, 2020; U.S. patent application Ser. No. 15/929,442, titled DENTAL APPLIANCES AND ASSOCIATED METHODS OF MANUFACTURING, filed May 2, 2020, International Application No. PCT/US20/70016, titled DENTAL APPLIANCES AND ASSOCIATED METHODS OF MANUFACTURING, filed May 2, 2020, U.S. Provisional Patent Application No. 62/956,290, filed Jan. 1, 2020, and U.S. Provisional Patent Application No. 62/842,391, filed May 2, 2019.

### TECHNICAL FIELD

The present technology relates to the field of orthodontics and, more particularly, to devices, systems, and methods for securing orthodontic appliances to a patient's teeth.

### BACKGROUND

A common objective in orthodontics is to move a patient's teeth to positions where the teeth function optimally and aesthetically. To move the teeth, the orthodontist begins by obtaining multiple scans and/or impressions of the patient's teeth to determine a series of corrective paths between the initial positions of the teeth and the desired ending positions. The orthodontist then fits the patient to one of two main appliance types: braces or aligners.

Traditional braces consist of brackets and an archwire placed across a front side of the teeth, with elastic ties or ligature wires to secure the archwire to the brackets. In some cases self-ligating brackets may be used in lieu of ties or wires. The shape and stiffness of the archwire as well as the archwire-bracket interaction governs the forces applied to the teeth and thus the direction and degree of tooth movement. To exert a desired force on the teeth, the orthodontist often manually bends the archwire. The orthodontist monitors the patient's progress through regular appointments, during which the orthodontist visually assesses the progress of the treatment and makes manual adjustments to the archwire (such as new bends) and/or replaces or repositions brackets. The adjustment process is both time consuming and tedious for the patient and more often than not results in patient discomfort for several days following the appointment. Moreover, braces are not aesthetically pleasing and make brushing, flossing, and other dental hygiene procedures difficult.

Aligners comprise clear, removable, polymeric shells having cavities shaped to receive and reposition teeth to produce a final tooth arrangement. Dubbed “invisible braces,” aligners offer patients significantly improved aesthetics over braces. Aligners do not require the orthodontists to bend wires or reposition brackets and are generally more comfortable than braces. However, unlike braces, aligners cannot effectively treat all malocclusions. Certain tooth repositioning steps, such as extrusion, translation, and certain rotations, can be difficult or impossible to achieve with aligners. Moreover, because the aligners are removable, success of treatment is highly dependent on patient compliance, which can be unpredictable and inconsistent.

Lingual braces are an alternative to aligners and traditional (buccal) braces and have been gaining popularity in recent years. Two examples of existing lingual braces are the Incognito™ Appliance System (3M United States) and INBRACE® (Swift Health Systems, Irvine, Calif., USA), each of which consists of brackets and an archwire placed on the lingual, or tongue side, of the teeth. In contrast to traditional braces, lingual braces are virtually invisible, and, unlike aligners, lingual braces are fixed to the patient's teeth and force compliance. These existing lingual technologies, however, also come with several disadvantages. Most notably, conventional lingual appliances still rely on a bracket-archwire system to move the teeth, thus requiring multiple office visits and painful adjustments. For example, lingual technologies have a relatively short inter-bracket distance, which generally makes compliance of the archwire stiffer. As a result, the overall lingual appliance is more sensitive to archwire adjustments and causes more pain for the patient. Moreover, the lingual surfaces of the appliance can irritate the tongue and impact speech, and make the appliance difficult to clean.

Therefore, a need exists for improved orthodontic appliances.

### SUMMARY

The subject technology is illustrated, for example, according to various aspects described below, including with reference to FIGS. 1-32. Various examples of aspects of the subject technology are described as numbered clauses (1, 2, 3, etc.) for convenience. These are provided as examples and do not limit the subject technology.

1. An orthodontic appliance configured to be positioned in a patient's mouth along the patient's teeth, the orthodontic appliance comprising:
a plurality of attachment portions, each configured to be secured to one of the patient's teeth via a securing member; and
a plurality of connectors, each connector extending between adjacent attachment portions,
wherein at least some of the attachment portions comprise first and second portions, wherein, when the appliance is installed in a patient's mouth, the first portions extend along a substantially mesiodistal dimension and the second portions extend along a substantially occlusogingival dimension such that the first and second portions are configured to abut portions of a securing member to substantially inhibit occlusogingival movement and mesiodistal movement of the attachment portion relative to the tooth to which it is attached.

2. The orthodontic appliance of Clause 1, wherein the orthodontic appliance is configured to be positioned in the patient's mouth to move the patient's teeth from an original tooth arrangement (OTA) to an intermediate or final tooth arrangement (ITA or FTA).

3. The orthodontic appliance of Clause 1, wherein the orthodontic appliance is configured to be permanently positioned in the patient's mouth as a retainer after the teeth have been treated and are in an FTA, and wherein the orthodontic appliance is configured to substantially maintain the positions of the teeth in the FTA.

4. The orthodontic appliance of Clause 1, wherein the orthodontic appliance is configured to be positioned in the patient's mouth to move the patient's teeth from an OTA to an FTA and remain in the patient's mouth as a retainer after the teeth are in the FTA to substantially maintain the positions of the teeth.

5. The orthodontic appliance of any one of Clauses 1 to 4, wherein the securing member is a bracket.

6. The orthodontic appliance of any one of Clauses 1 to 4, wherein the securing member is a composite material.

7. The orthodontic appliance of any one of Clauses 1 to 4, wherein the securing member comprises both a bracket and a composite material.

8. The orthodontic appliance of any one of Clauses 1 to 7, wherein the second portion is substantially perpendicular to the first portion.

9. The orthodontic appliance of any one of Clauses 1 to 8, wherein the attachment portions and the connectors are different portions of a monolithic, unitarily-formed structure.

10. A securing member for securing an attachment portion of an orthodontic appliance to a tooth of a patient, the securing member comprising:
a first side configured to be positioned against a surface of the patient's tooth;
a second side opposite the first side and configured to face away from the patient's tooth, wherein the second side of the securing member comprises:
   a surface having a plurality of topographical features that increase a surface area of the surface as compared to a surface area of the surface without the topographical features; and
   a protrusion extending away from the surface, wherein the protrusion comprises:
      a mesially-facing surface configured to abut a distally-facing surface of a corresponding attachment portion and thereby inhibit distal movement of the attachment portion,
      a distally-facing surface configured to abut a mesially-facing surface of a corresponding attachment portion and thereby inhibit mesial movement of the attachment portion,
      an occlusally-facing surface configured to abut a gingivally-facing surface of a corresponding attachment portion and thereby inhibit gingival movement of the attachment portion, and
      a gingivally-facing surface configured to abut an occlusally-facing surface of a corresponding attachment portion and thereby inhibit occlusal movement of the attachment portion.

11. The securing member of Clause 10, wherein the protrusion comprises a first protrusion and a second protrusion spaced apart from the first protrusion along the surface.

12. The securing member of Clause 10, wherein protrusion comprises four protrusions spaced apart from one another along the surface, wherein each of the protrusions has at least one of a mesially-facing surface or distally-facing surface and at least one of an occlusally-facing surface and a gingivally-facing surface.

13. The securing member of any one of Clauses 10 to 12, wherein the first side of the securing member does not include any topographical features and/or protrusions.

14. The securing member of any one of Clauses 10 to 13, wherein the topographical features comprise a plurality of depressions.

15. The securing member of any one of Clauses 10 to 14, wherein the topographical features comprise a plurality of bumps.

16. The securing member of any one of Clauses 10 to 15, wherein the topographical features are disposed on the protrusion.

17. The securing member of any one of Clauses 10 to 15, wherein the topographical features are not disposed on the protrusion.

18. The securing member of any one of Clauses 10 to 17, wherein the protrusion comprises a plurality of protrusions and the protrusions are spaced apart along the surface, thereby defining a recess between the protrusions, and wherein the recess is configured to receive a complementary attachment portion therein.

19. The securing member of Clause 18, wherein the recess comprises a cross shape.

20. The securing member of any one of Clauses 10 to 19, wherein the securing member is configured to be positioned at a lingual surface of a patient's tooth.

21. A method, comprising:
securing a bracket on a surface of a tooth, the bracket having a first support and a second support spaced apart by a gap, wherein each of the first and second supports are configured to extend away from the tooth when the bracket is secured to the tooth;
positioning a portion of an orthodontic appliance in the gap, wherein the orthodontic appliance is configured to move the tooth from an original position to an intermediate position or a final position and/or retain the tooth in its current position;
positioning a curable composite material over the first and second portions, the gap, and at least the portion of the appliance in the gap, thereby securing the appliance to the bracket.

22. The method of Clause 21, wherein the bracket is a non-curable material.

23. The method of Clause 21, wherein the bracket comprises a metal.

24. A securing member for securing an attachment portion of an orthodontic appliance to a tooth of a patient, the securing member comprising:
a first support configured to extend away from the tooth when the securing member is secured to the tooth, wherein the first support has an occlusally-facing surface configured to abut a gingivally-facing surface of the attachment portion and thereby inhibit gingival movement of the attachment portion; and
a second support configured to extend away from the tooth when the securing member is secured to the tooth, wherein the second support is spaced apart from the first support by a gap when the securing member is secured to the tooth, the gap being configured to receive the attachment portion therein, and wherein the second support has:
   a mesially-facing surface configured to abut a distally-facing surface of the attachment portion and thereby inhibit distal movement of the attachment portion,
   a distally-facing surface configured to abut a mesially-facing surface of the attachment portion and thereby inhibit mesial movement of the attachment portion, and
   a gingivally-facing surface configured to abut an occlusally-facing surface of the attachment portion and thereby inhibit occlusal movement of the attachment portion,
wherein, when the attachment portion is positioned within the gap, the securing member is configured to receive a curable composite material over the first support, the second support, the gap, and the attachment portion, thereby securing the attachment portion within the gap.

25. The securing member of Clause 24, wherein no portion of the bracket extends over the attachment portion when the attachment portion is positioned in the gap.

26. The securing member of Clause 24, wherein no portion of the bracket extends over a lingual surface of the attachment portion when the attachment portion is positioned in the gap.

27. The securing member of Clause 24, wherein no portion of the bracket extends over a buccal surface of the attachment portion when the attachment portion is positioned in the gap.

28. The securing member of any one of Clauses 24 to 27, further comprising a backing having a first side configured to be positioned against a surface of the patient's tooth and a second side opposite the first side and configured to face away from the patient's tooth, wherein the first and second supports are attached to and extend away from the backing such that the backing is positioned between the first and second supports and the surface of the tooth when the securing member is secured to the tooth.

29. The securing member of Clause 28, wherein the backing spans the gap between the first and second supports such that, when the attachment portion is secured to the securing member, the backing is positioned between the attachment portion and the surface of the tooth.

30. The securing member of any one of Clauses 24 to 29, wherein the gap is configured to receive a wire therein.

31. The securing member of any one of Clauses 24 to 30, wherein the gap has a shape that mimics a shape of the attachment portion configured to be received within the gap.

32. The securing member of any ones of Clauses 24 to 31, wherein the gap is generally U-shaped, and wherein, when the securing member is secured to the tooth, an open end of the U-shape is occlusal to a closed end of the U-shape.

33. The securing member of any one of Clauses 24 to 32, wherein the gap is configured to receive a bent wire therein.

34. The securing member of Clause 33, wherein the second support is configured to abut a portion of the bent wire that is concave in an occlusal direction when the attachment portion is positioned within the gap.

35. The securing member of Clause 33 or Clause 34, wherein the first support is configured to abut a portion of the bent wire that is convex in a gingival direction when the attachment portion is positioned within the gap.

36. The securing member of any one of Clauses 24 to 35, wherein the gingivally-facing surface of the second support is curved and, at least when the securing member is secured to the tooth, is convex in a gingival direction.

37. The securing member of any one of Clauses 24 to 36, wherein the occlusally-facing surface of the first support is curved and, at least when the securing member is secured to the tooth, is convex in a gingival direction.

38. The securing member of any one of Clauses 24 to 37, wherein a width of the gap is slightly greater than a width of the attachment portion.

39. The securing member of any one of Clauses 24 to 38, wherein the opposing surfaces of the first and second supports on either side of the gap have shapes that substantially conform to one another.

40. A securing member for securing an attachment portion of an orthodontic appliance to a tooth of a patient, the securing member comprising:
a first support configured to extend away from the tooth when the securing member is secured to the tooth, wherein the first support has a gingivally-facing surface configured to abut an occlusally-facing surface of the attachment portion and thereby inhibit occlusal movement of the attachment portion; and
a second support configured to extend away from the tooth when the securing member is secured to the tooth, wherein the second support is spaced apart from the first support by a gap when the securing member is secured to the tooth, the gap configured to receive the attachment portion therein, and wherein the second support has:
   a mesially-facing surface configured to abut a distally-facing surface of the attachment portion and thereby inhibit distal movement of the attachment portion,
   a distally-facing surface configured to abut a mesially-facing surface of the attachment portion and thereby inhibit mesial movement of the attachment portion, and
   an occlusally-facing surface configured to abut a gingivally-facing surface of a corresponding attachment portion and thereby inhibit gingival movement of the attachment portion.

41. The securing member of Clause 40, wherein no portion of the bracket extends over the attachment portion when the attachment portion is positioned in the gap.

42. The securing member of Clause 40, wherein no portion of the bracket extends over a lingual surface of the attachment portion when the attachment portion is positioned in the gap.

43. The securing member of Clause 40, wherein no portion of the bracket extends over a buccal surface of the attachment portion when the attachment portion is positioned in the gap.

44. The securing member of any one of Clauses 40 to 43, further comprising a backing having a first side configured to be positioned against a surface of the patient's tooth and a second side opposite the first side and configured to face away from the patient's tooth, wherein the first and second supports are attached to and extend away from the backing such that the backing is positioned between the first and second supports and the surface of the tooth when the securing member is secured to the tooth.

45. The securing member of Clause 44, wherein the backing spans the gap between the first and second supports such that, when the attachment portion is secured to the securing member, the backing is positioned between the attachment portion and the surface of the tooth.

46. The securing member of any one of Clauses 40 to 45, wherein the gap is configured to receive a wire therein.

47. The securing member of any one of Clauses 40 to 46, wherein the gap has a shape that mimics a shape of the attachment portion configured to be received within the gap.

48. The securing member of any ones of Clauses 40 to 47, wherein the gap is generally U-shaped, and wherein, when the securing member is secured to the tooth, an open end of the U-shape is gingival to a closed end of the U-shape.

49. The securing member of any one of Clauses 40 to 48, wherein the gap is configured to receive a bent wire therein.

50. The securing member of Clause 49, wherein the second support is configured to abut a portion of the bent wire that is concave in a gingival direction when the attachment portion is positioned within the gap.

51. The securing member of Clause 49 or Clause 50, wherein the first support is configured to abut a portion of the bent wire that is concave in a gingival direction when the attachment portion is positioned within the gap.

52. The securing member of any one of Clauses 40 to 51, wherein the occlusally-facing surface of the second support is curved and, at least when the securing member is secured to the tooth, is convex in an occlusal direction.

53. The securing member of any one of Clauses 40 to 52, wherein the gingivally-facing surface of the first support is curved and, at least when the securing member is secured to the tooth, is concave in a gingival direction.

54. The securing member of any one of Clauses 40 to 53, wherein a width of the gap is slightly greater than a width of the attachment portion.

55. The securing member of any one of Clauses 40 to 54, wherein the opposing surfaces of the first and second supports on either side of the gap have shapes that substantially conform to one another.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIGS. 1 and 2 schematically illustrate directional references relative to a patient's dentition.

FIG. 3A shows the schematic representation of an orthodontic appliance configured in accordance with the present technology installed in a patient's mouth adjacent the patient's dentition.

FIG. 3B is a schematic depiction of connection configuration options configured in accordance with embodiments of the present technology.

FIG. 3C is a schematic depiction of a portion of an appliance configured in accordance with embodiments of the present technology.

FIGS. 4A and 4B are elevation views of an appliance configured in accordance with several embodiments of the present technology installed in an upper and lower jaw of a patient's mouth with the patient's teeth in an original tooth arrangement and a final tooth arrangement, respectively.

FIG. 4C is a graph showing the stress-strain curves for nitinol and steel.

FIG. 5 is an isometric view of a connection configuration in accordance with examples of the present technology.

FIG. 6 is an isometric view of a connection configuration in accordance with examples of the present technology.

FIG. 7 is an isometric view of a connection configuration in accordance with examples of the present technology.

FIG. 8 is an isometric view of a connection configuration in accordance with examples of the present technology.

FIG. 9 is an isometric view of a connection configuration in accordance with examples of the present technology.

FIG. 10 is an isometric view of a connection configuration in accordance with examples of the present technology.

FIG. 11A illustrates an orthodontic appliance configured in accordance with several embodiments of the present technology, shown positioned in a patient's mouth.

FIG. 11B is an enlarged view of a portion of the orthodontic appliance shown in FIG. 11A.

FIG. 11C is a cross-sectional side view taken along 11C-11C in FIG. 11B.

FIG. 11D is a variation on the cross-sectional side view shown in FIG. 11C.

FIG. 12A is an enlarged view of a portion of an orthodontic appliance and securing member configured in accordance with embodiments of the present technology.

FIG. 12B is an enlarged view of a portion of an orthodontic appliance and securing member configured in accordance with embodiments of the present technology.

FIG. 12C is an isolated view of the securing member shown in FIG. 12B.

FIG. 13A illustrates an orthodontic appliance configured in accordance with several embodiments of the present technology, shown positioned in a patient's mouth.

FIG. 13B is an enlarged view of a portion of the orthodontic appliance shown in FIG. 13A.

FIG. 14 illustrates an orthodontic appliance configured in accordance with several embodiments of the present technology, shown positioned within a patient's mouth.

FIGS. 15A-15R show attachment portions configured in accordance with embodiments of the present technology.

FIG. 16 illustrates a plan view of an orthodontic appliance configured in accordance with embodiments of the present technology.

FIG. 17 shows the orthodontic appliance shown in FIG. 16 positioned in a patient's mouth.

FIGS. 18 and 19 are plan views of orthodontic appliances configured in accordance with embodiments of the present technology.

FIGS. 20A and 20B are enlarged views of an attachment portion of an orthodontic appliance configured in accordance with the present technology.

FIGS. 21 and 22 are plan views of orthodontic appliances configured in accordance with embodiments of the present technology.

FIGS. 23 and 24 are isometric views of orthodontic appliances configured in accordance with embodiments of the present technology.

FIG. 25A shows a tool configured in accordance with embodiments of the present technology.

FIG. 25B is an enlarged view of a distal portion of the tool shown in FIG. 25A.

FIG. 26 shows a tool configured in accordance with embodiments of the present technology.

FIG. 27 is an isometric view of a securing member configured in accordance with embodiments of the present technology.

FIG. 28 is an isometric view of an attachment portion of an orthodontic appliance coupled to a securing member, configured in accordance with embodiments of the present technology.

FIGS. 29 and 30 are isometric views of securing members configured in accordance with embodiments of the present technology.

FIG. 31 shows a securing member configured in accordance with several embodiments of the present technology.

FIG. 32 shows an attachment portion of the present technology received within the securing member shown in FIG. 31.

### DETAILED DESCRIPTION

### I. Definitions

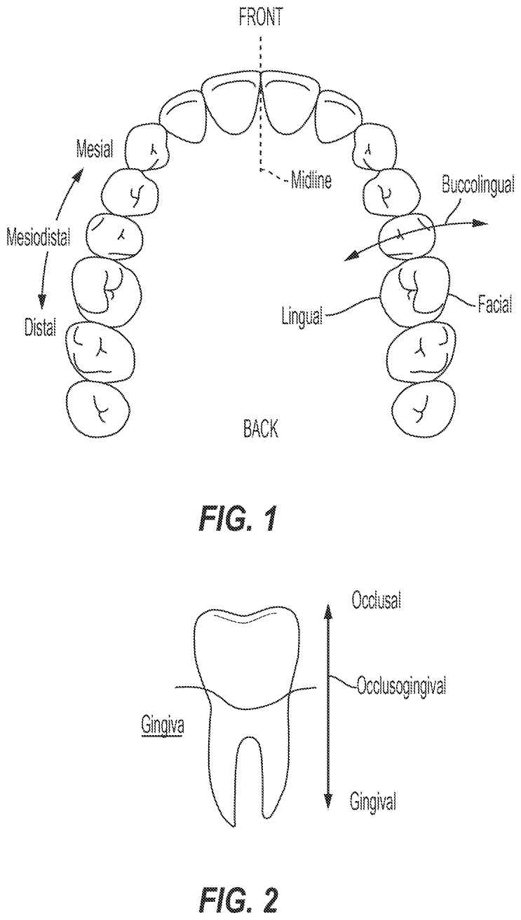

FIGS. 1 and 2 schematically depict several directional terms related to a patient's dentition. Terms used herein to provide anatomical direction or orientation are intended to encompass different orientations of the appliance as installed in the patient's mouth, regardless of whether the structure being described is shown installed in a mouth in the drawings. As illustrated in FIGS. 1 and 2: “mesial” means in a direction toward the midline of the patient's face along the patient's curved dental arch; “distal” means in a direction away from the midline of the patient's face along the patient's curved dental arch; “occlusal” means in a direction toward the chewing surfaces of the patient's teeth; “gingival” means in a direction toward the patient's gums or gingiva; “facial” means in a direction toward the patient's lips or cheeks (used interchangeably herein with “buccal” and “labial”); and “lingual” means in a direction toward the patient's tongue.

As used herein, the terms “proximal” and “distal” refer to a position that is closer and farther, respectively, from a given reference point. In many cases, the reference point is a certain connector, such as an anchor, and “proximal” and “distal” refer to a position that is closer and farther, respectively, from the reference connector along a line passing through the centroid of the cross-section of the portion of the appliance branching from the reference connector.

As used herein, the terms “generally,” “substantially,” “about,” and similar terms are used as terms of approximation and not as terms of degree, and are intended to account for the inherent variations in measured or calculated values that would be recognized by those of ordinary skill in the art.

As used herein, the term “operator” refers to a clinician, practitioner, technician or any person or machine that designs and/or manufactures an orthodontic appliance or portion thereof, and/or facilitates the design and/or manufacture of the appliance or portion thereof, and/or any person or machine associated with installing the appliance in the patient's mouth and/or any subsequent treatment of the patient associated with the appliance.

As used herein, the term “force” refers to the magnitude and/or direction of a force, a torque, or a combination thereof.

### II. Overview of Orthodontic Appliances of the Present Technology

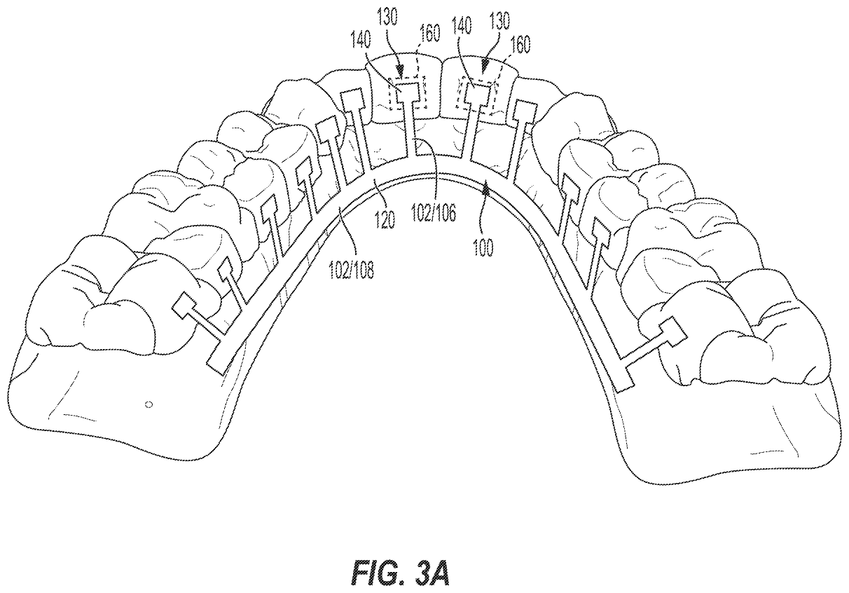

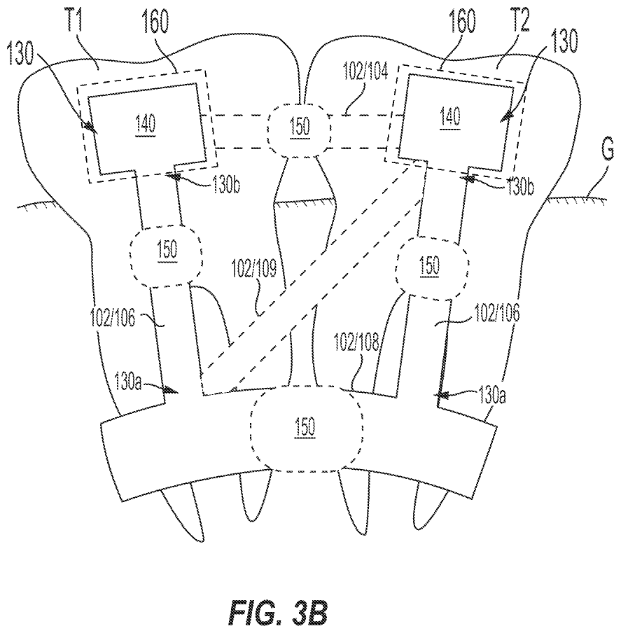

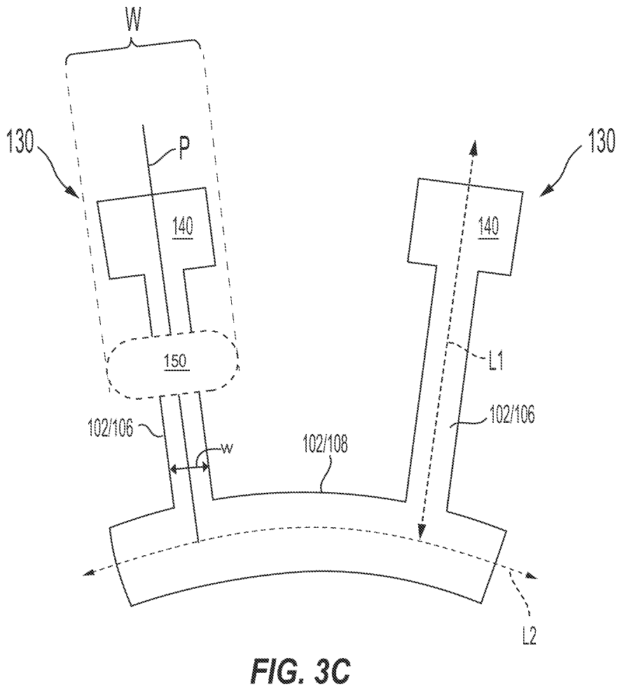

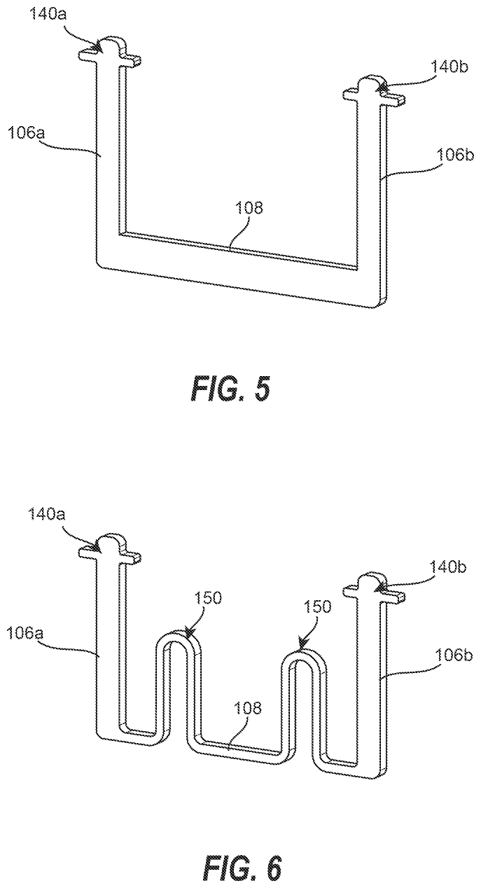

FIG. 3A is a schematic representation of an orthodontic appliance 100 (or “appliance 100”) configured in accordance with embodiments of the present technology, shown positioned in a patient's mouth adjacent the patient's teeth. FIG. 3B is an enlarged view of a portion of the appliance 100. The appliance 100 is configured to be installed within a patient's mouth to impart forces on one or more of the teeth to reposition all or some of the teeth. In some cases, the appliance 100 may additionally or alternatively be configured to maintain a position of one or more teeth, for example as a retainer. As shown schematically in FIGS. 3A and 3B, the appliance 100 can comprise a deformable member that includes one or more attachment portions 140 (each represented schematically by a box), each configured to be secured to a tooth surface directly or indirectly via a securing member 160. The appliance 100 may further comprise one or more connectors 102 (also depicted schematically), each extending directly between attachment portions 140 (“first connectors 104”), between an attachment portion 140 and one or more other connectors 102 (“second connectors 106”), or between two or more other connectors 102 (“third connectors 108”). Only two attachment portions 140 and two connectors 102 are labeled in FIG. 3A for ease of illustration. As discussed herein, the number, configuration, and location of the connectors 102 and attachment portions 140 may be selected to provide a desired force on one or more of the teeth when the appliance 100 is installed. Additional details regarding different configurations of connectors 102 are provided elsewhere herein, for example below with reference to FIGS. 5-24.

The attachment portions 140 may be configured to be detachably coupled to a securing member 160 that is bonded, adhered, or otherwise secured to a surface of one of the teeth to be moved. In some embodiments, one or more of the attachment portions 140 may be directly bonded, adhered, or otherwise secured to a corresponding tooth without a securing member or other connection interface at the tooth. The attachment portions 140 may also be referred to as “bracket connectors” or “male connector elements” herein. The different attachment portions 140 of a given appliance 100 may have the same or different shape, same or different size, and/or same or different configuration. The attachment portions 140 may comprise any one or combination of the attachment portions disclosed herein (including but not limited to attachment portions 1104, 1204, 1204′, 1304, 1404, 1504, 1604, 1804, 1904, 2004, 2104, 2204, 2304, and 2404), any one of the bracket connectors and/or male connector elements disclosed herein, as well as any of the attachment portions, bracket connectors, and/or male connector elements disclosed in U.S. patent application Ser. No. 15/370,704 (Publ. No. 2017/0156823) filed Dec. 6, 2016, which is incorporated by reference herein in its entirety.

The appliance 100 may include any number of attachment portions 140 suitable for securely attaching the appliance 100 to the patient's tooth or teeth in order to achieve a desired movement. In some examples, multiple attachment portions 140 may be attached to a single tooth. The appliance 100 may include an attachment portion for every tooth, fewer attachment portions than teeth, or more attachment portions 140 than teeth. In these and other embodiments, the appliance 100 one or more of the attachment portions 140 may be configured to be coupled to one, two, three, four, five or more connectors 102.

As previously mentioned, the connectors 102 may comprise one or more first connectors 104 that extend directly between attachment portions 140. The one or more first connectors 104 may extend along a generally mesiodistal dimension when the appliance 100 is installed in the patient's mouth. In these and other embodiments, the appliance 100 may include one or more first connectors 104 that extend along a generally occlusogingival and/or buccolingual dimension when the appliance 100 is installed in the patient's mouth. In some embodiments, the appliance 100 does not include any first connectors 104.

Additionally or alternatively, the connectors 102 may comprise one or more second connectors 106 that extend between one or more attachment portions 140 and one or more connectors 102. The one or more second connectors 106 can extend along a generally occlusogingival dimension when the appliance 100 is installed in the patient's mouth. In these and other embodiments, the appliance 100 may include one or more second connectors 106 that extend along a generally mesiodistal and/or buccolingual dimension when the appliance 100 is installed in the patient's mouth. In some embodiments, the appliance 100 does not include any second connectors 106. In such embodiments, the appliance 100 would only include first connectors 104 extending between attachment portions 140. A second connector 106 and the attachment portion 140 to which it is attached may comprise an “arm,” as used herein (such as arm 130 in FIGS. 3A and 3B). In some embodiments, multiple second connectors 106 may extend from the same location along the appliance 100 to the same attachment portion 140. In such cases, the multiple second connectors 106 and the attachment portion 140 together comprise an “arm,” as used herein. The use of two or more connectors to connect two points on the appliance 100 enables application of a greater force (relative to a single connector connecting the same points) without increasing the strain on the individual connectors. Such a configuration is especially beneficial given the spatial constraints of the fixed displacement treatments herein.

Additionally or alternatively, the connectors 102 may comprise one or more third connectors 108 that extend between two or more other connectors 102. The one or more third connectors 108 may extend along a generally mesiodistal dimension when the appliance 100 is installed in the patient's mouth. In these and other embodiments, the appliance 100 may include one or more third connectors 108 that extend along a generally occlusogingival and/or buccolingual dimension when the appliance 100 is installed in the patient's mouth. In some embodiments, the appliance 100 does not include any third connectors 108. One, some, or all of the third connectors 108 may be positioned gingival to one, some, or all of the first connectors 104. In some embodiments, the appliance 100 includes a single third connector 108 that extends along at least two adjacent teeth and provides a common attachment for two or more second connectors 106. In several embodiments, the appliance 100 includes multiple non-contiguous third connectors 108, each extending along at least two adjacent teeth.

As shown in FIG. 3A, in some embodiments the appliance 100 may be configured such that all or a portion of one, some, or all of the connectors 102 are disposed proximate the patient's gingiva when the appliance 100 is installed within the patient's mouth. For example, one or more third connectors 108 may be configured such that all or a portion of the one or more third connectors 108 is positioned below the patient's gum line and adjacent to but spaced apart from the gingiva. In many cases it may be beneficial to provide a small gap (e.g., 0.5 mm or less) between the third connector(s) 108 and the patient's gingiva, as contact between the third connector(s) 108 (or any portion of the appliance 100) and the gingiva can cause irritation and patient discomfort. In some embodiments, all or a portion of the third connector(s) 108 is configured to be in direct contact with the gingiva when the appliance 100 is disposed in the patient's mouth. Additionally or alternatively, all or a portion of one or more first connectors 104 and/or second connectors 106 may be configured to be disposed proximate the gingiva.

According to some embodiments, one or more connectors 102 may extend between an attachment portion 140 or connector 102 and a joint comprising (a) two or more connectors 102, (b) two or more attachment portions 140, or (c) at least one attachment portion 140 and at least one connector 102. According to some embodiments, one or more connectors 102 may extend between a first joint comprising (a) two or more connectors 102, (b) two or more attachment portions 140, or (c) at least one attachment member and at least one connector 102, and a second joint comprising (a) two or more connectors 102, (b) two or more attachment portions 140, or (c) at least one attachment portion 140 and at least one connector 102. An example of a connector 102 extending between (a) a joint between a second and third connector 106, 108, and (b) a joint between a second connector 106 and an attachment portion 140 is depicted schematically and labeled 109 in FIG. 3B.

Each of the connectors 102 may be designed to have a desired stiffness so that an individual connector 102 or combination of connectors 102 imparts a desired force on one or more of the teeth. In many cases, the force applied by a given connector 102 may be governed by Hooke's Law, or F=k×x, where F is the restoring force exerted by the connector 102, k is the stiffness coefficient of the connector 102, and x is the displacement. In the most basic example, if a connector 102 does not exist between two points on the appliance 100, then the stiffness coefficient along that path is zero and no forces are applied. In the present case, the individual connectors 102 of the present technology may have varying non-zero stiffness coefficients. For example, one or more of the connectors 102 may be rigid (i.e., the stiffness coefficient is infinite) such that the connector 102 will not flex or bend between its two end points. In some embodiments, one or more of the connectors 102 may be “flexible” (i.e., the stiffness coefficient is non-zero and positive) such that the connector 102 can deform to impart (or absorb) a force on the associated tooth or teeth or other connector 102.

In some embodiments it may be beneficial to include one or more rigid connectors between two or more teeth. A rigid connector 102 is sometimes referred to herein as a “rigid bar” or an “anchor.” Each rigid connector 102 may have sufficient rigidity to hold and maintain its shape and resist bending. The rigidity of the connector 102 can be achieved by selecting a particular shape, width, length, thickness, and/or material. Connectors 102 configured to be relatively rigid may be employed, for example, when the tooth to be connected to the connector 102 or arm is not to be moved (or moved by a limited amount) and can be used for anchorage. Molar teeth, for example, can provide good anchorage as molar teeth have larger roots than most teeth and thus require greater forces to be moved. Moreover, anchoring one or more portions of the appliance 100 to multiple teeth is more secure than anchoring to a single tooth. As another example, a rigid connection may be desired when moving a group of teeth relative to one or more other teeth. Consider, for instance, a case in which the patient has five teeth separated from a single tooth by a gap, and the treatment plan is to close the gap. The best course of treatment is typically to move the one tooth towards the five teeth, and not vice versa. In this case, it may be beneficial to provide one or more rigid connectors between the five teeth. For all of the foregoing reasons and many others, the appliance 100 may include one or more rigid first connectors 104, one or more rigid second connectors 106, and/or one or more rigid third connectors 108.

In these and other embodiments, the appliance 100 may include one or more flexible first connectors 104, one or more flexible second connectors 106, and/or one or more flexible third connectors 108. Each flexible connector 102 may have a particular shape, width, thickness, length, material, and/or other parameters to provide a desired degree of flexibility. According to some embodiments of the present technology, the stiffness of a given connector 102 may be tuned via incorporation of a one or more resiliently flexible biasing portions 150. As shown schematically in FIG. 3B, one, some, or all of the connectors 102 may include one or more biasing portion 150, such as springs, each configured to apply a customized force specific to the tooth to which it is attached.

As depicted in the schematic shown in FIG. 3C, the biasing portion(s) 150 may extend along all or a portion of the longitudinal axis L1 of the respective connector 102 (only the longitudinal axis L1 for second connector 106 and the longitudinal axis L2 for third connector 108 is labeled in FIG. 3C). The direction and magnitude of the force and torque applied on a tooth by a biasing portion 150 depends, at least in part, on the shape, width, thickness, length, material, shape set conditions, and other parameters of the biasing portion 150. As such, one or more aspects of the biasing portion 150 (including the aforementioned parameters) may be varied so that the corresponding arm 130, connector 102, and/or biasing portion 150 produces a desired tooth movement when the appliance 100 is installed in the patient's mouth. Each arm 130 and/or biasing portion 150 may be designed to move one or more teeth in one, two, or all three translational directions (i.e., mesiodistal, buccolingual, and occlusogingival) and/or in one, two, or all three rotational directions (i.e., buccolingual root torque, mesiodistal angulation and mesial out-in rotation).

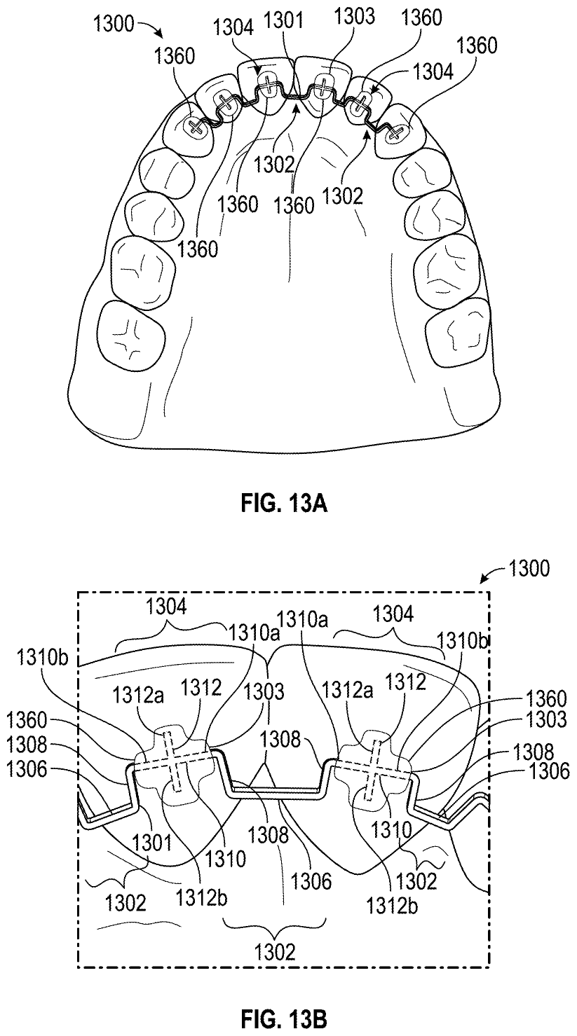

The biasing portions 150 of the present technology can have any length, width, shape, and/or size sufficient to move the respective tooth towards a desired position. In some embodiments, one, some, or all of the connectors 102 may have one or more inflection points along a respective biasing portion 150. The connectors 102 and/or biasing portions 150 may have a serpentine configuration such that the connector 102 and/or biasing portion 150 doubles back on itself at least one or more times before extending towards the attachment portion 140. For example, in some embodiments the second connectors 106 double back on themselves two times along the biasing portion 150, thereby forming first and second concave regions facing in generally different directions relative to one another (as an example, see FIG. 13B). The open loops or overlapping portions of the connector 102 corresponding to the biasing portion 150 may be disposed on either side of a plane P (FIG. 3C) bisecting an overall width W (FIG. 3C) of the arm 130 and/or connector 102 such that the extra length of the arm 130 and/or connector 102 is accommodated by the space medial and/or distal to the arm 130 and/or connector 102. This allows the arm 130 and/or connector 102 to have a longer length (as compared to a linear arm) to accommodate greater tooth movement, despite the limited space in the occlusal-gingival or vertical dimension between any associated third connector 108 and the location at which the arm 130 attaches to the tooth.

It will be appreciated that the biasing portion 150 may have other shapes or configurations. For example, in some embodiments the connector 102 and/or biasing portion 150 may include one or more linear regions that zig-zag towards the attachment portion 140. One, some, or all of the connectors 102 and/or biasing portions 150 may have only linear segments or regions, or may have a combination of curved and linear regions. In some embodiments, one, some, or all of the connectors 102 and/or biasing portions 150 do not include any curved portions.

According to some examples, a single connector 102 may have multiple biasing portions 150 in series along the longitudinal axis of the respective connector 102. In some embodiments, multiple connectors 102 may extend between two points along the same or different paths. In such embodiments, the different connectors 102 may have the same stiffness or different stiffnesses.

In those embodiments where the appliance 100 has two or more connectors 102 with biasing portions 150, some, none, or all of the connectors 102 may have the same or different lengths, the same or different widths, the same or different thicknesses, the same or different shapes, and/or may be made of the same or different materials, amongst other properties. In some embodiments, less than all of the connectors 102 have biasing portions 150. Connectors 102 without biasing portions 150 may, for example, comprise one or more rigid connections between a rigid third connector 108 and the attachment portion 140. In some embodiments, none of the connectors 102 of the appliance 100 have a biasing portion 150.

According to some embodiments, for example as depicted schematically in FIG. 3A, the appliance 100 may include a single, continuous, substantially rigid third connector (referred to as “anchor 120”) and a plurality of flexible arms 130 extending away from the anchor 120. When the appliance 100 is installed in the patient's mouth, each of the arms 130 may connect to a different one of the teeth to be moved and exerts a specific force on its respective tooth, thereby allowing an operator to move each tooth independently. Such a configuration provides a notable improvement over traditional braces in which all of the teeth are connected by a single archwire, such that movement of one tooth can cause unintentional movement of one or more nearby teeth. As discussed in greater detail herein, the independent and customized tooth movement enabled by the appliances of the present technology allows the operator to move the teeth from an original tooth arrangement (“OTA”) to a final tooth arrangement (“FTA”) more efficiently, thereby obviating periodic adjustments, reducing the number of office visits, and reducing or eliminating patient discomfort, and reducing the overall treatment time (i.e., the length of time the appliance is installed in the patient's mouth) by at least 50% relative to the overall treatment time for traditional braces. Moreover, the independent and customized tooth movements enabled by the present technology allow the device to be used to retain one or more teeth in their final positions. In some embodiments, the same appliance can be used to both move the teeth to a desired position and hold the teeth in that position.

The anchor 120 may comprise any structure of any shape and size configured to comfortably fit within the patient's mouth and provide a common support for one or more of the arms 130. In many embodiments, the anchor 120 is disposed proximate the patient's gingiva when the appliance 100 is installed within the patient's mouth, for example as shown in FIG. 3B. For instance, the appliance may be designed such that, when installed in the patient's mouth, all or a portion of the anchor 120 is positioned below the patient's gum line and adjacent but spaced apart from the gingiva. In many cases it may be beneficial to provide a small gap (e.g., 0.5 mm or less) between the anchor 120 (or any portion of the appliance 100) and the patient's gingiva as contact between the anchor 120 and the gingiva can cause irritation and patient discomfort. In some embodiments, all or a portion of the anchor 120 is configured to be in contact with the gingiva when the appliance 100 is disposed in the patient's mouth.

The anchor 120 may be significantly more rigid than the arms 130 such that the equal and opposite forces experienced by each of the arms 130 when exerting a force on its respective tooth are countered by the rigidity of the anchor 120 and the forces applied by the other arms 130, and do not meaningfully affect the forces on other teeth. As such, the anchor 120 effectively isolates the forces experienced by each arm 130 from the rest of the arms 130, thereby enabling independent tooth movement.

According to some embodiments, for example as shown schematically in FIGS. 3A and 3B, the anchor 120 comprises an elongated member having a longitudinal axis L2 (see FIG. 3C) and forming an arched shape configured to extend along a patient's jaw when the appliance 100 is installed. In these and other embodiments, the anchor 120 may be shaped and sized to span two or more of the patient's teeth when positioned in the patient's mouth. In some examples, the anchor 120 includes a rigid, linear bar, or may comprise a structure having both linear and curved segments. In these and other embodiments, the anchor 120 may extend laterally across all or a portion of the patient's mouth (e.g., across all or a portion of the palate, across all or a portion of the lower jaw, etc.) and/or in a generally anterior-posterior direction. Moreover, the appliance 100 may comprise a single anchor or multiple anchors. For example, the appliance 100 may comprise multiple, discrete, spaced apart anchors, each having two or more arms 130 extending therefrom. In these and other embodiments, the appliance 100 may include one or more other connectors extending between adjacent arms 130.

Any and all of the features discussed above with respect to anchor 120 applies to any of the third connectors 108 disclosed herein.

As shown in FIG. 3B, each of the arms 130 may extend between a proximal or first end portion 130a and a distal or second end portion 130b, and may have a longitudinal axis L extending between the first end portion 130a and the second end portion 130b. The first end portion 130a of one, some, or all of the arms 130 may be disposed at the anchor 120 and/or third connector 102/108. In some embodiments, one, some, or all of the arms 130 are integral with the anchor 120 such that the first end portion 130a of such arms are continuous with the anchor 120. The arms 130 may extend from the anchor 120 at spaced intervals along the longitudinal axis L2 of the anchor 120 and/or third connector 102/108, as shown in FIGS. 3A-3C. In some embodiments, the arms 130 may be spaced at even intervals relative to each other, or at uneven intervals relative to each other, along the longitudinal axis L2 of the anchor 120.

One, some, or all of the arms 130 may include an attachment portion 140 at or near the second end portion 130b. In some embodiments, for example as shown in FIGS. 3A-3C, one or more of the arms 130 is cantilevered from the anchor 120 such that the second end portion 130b of the cantilevered arm(s) 130 has a free distal end portion 130b. In these and other embodiments, a distal terminus of the attachment portion 140 may coincide with a distal terminus of the arm 130. The attachment portion 140 may be configured to detachably couple the respective arm 130 to a securing member (e.g., a bracket) that is bonded, adhered, or otherwise secured to a surface of one of the teeth to be moved. In some embodiments, the attachment portion 140 may be directly bonded, adhered, or otherwise secured to a corresponding tooth without a securing member or other connection interface at the tooth.

Referring still to FIGS. 3A and 3B, one, some, or all of the arms 130 may include one or more resiliently flexible biasing portions 150 (shown schematically in FIG. 3B), such as springs, each configured to apply a customized force, torque or combination of force and torque specific to the tooth to which it is attached. The biasing portion(s) 150 may extend along all or a portion of the longitudinal axis L1 of the respective arm 130 (see FIG. 3C) between the anchor 120 and the attachment portion 140. The direction and magnitude of the force and torque applied on a tooth by a biasing portion 150 depends, at least in part, on the shape, width, thickness, length, material, shape set conditions, and other parameters of the biasing portion 150. As such, one or more aspects of the arm 130 and/or biasing portion 150 (including the aforementioned parameters) may be varied so that the arm 130 and/or biasing portion 150 produce a desired tooth movement when the appliance 100 is installed in the patient's mouth. Each arm 130 and/or biasing portion 150 may be designed to move one or more teeth in one, two, or all three translational directions (i.e., mesiodistal, buccolingual, and occlusogingival) and/or in one, two, or all three rotational directions (i.e., buccolingual root torque, mesiodistal angulation and mesial out-in rotation).

The biasing portions 150 of the present technology can have any length, width, shape, and/or size sufficient to move the respective tooth towards a desired FTA and/or to hold the teeth in the desired FTA. In some embodiments, one, some, or all of the arms 130 may have one or more inflection points along a respective biasing portion 150. The arms 130 and/or biasing portions 150 may have a serpentine configuration such that the arm 130 and/or biasing portion 150 doubles back on itself at least one or more times before extending towards the attachment portion 140. In FIG. 3B, the arm 130 doubles back on itself two times along the biasing portion 150, thereby forming first and second concave regions facing in generally different directions relative to one another. The open loops or overlapping portions of the arm 130 corresponding to the biasing portion 150 may be disposed on either side of a plane P bisecting an overall width W of the arm 130 such that the extra length of the arm 130 is accommodated by the space medial and/or distal to the arm 130. This allows the arm 130 to have a longer length (as compared to a linear arm) to accommodate greater tooth movement, despite the limited space in the occlusal-gingival or vertical dimension between the anchor 20 and the location at which the arm 130 attaches to the tooth.

It will be appreciated that the biasing portion 150 may have other shapes or configurations. For example, in some embodiments the arm 130 and/or biasing portion 150 may include one or more linear regions that zig-zag towards the attachment portion 140. One, some, or all of the arms 130 and/or biasing portions 150 may have only linear segments or regions, or may have a combination of curved and linear regions. In some embodiments, one, some, or all of the arms 130 and/or biasing portions 150 do not include any curved portions.

According to some examples, a single arm 130 may have multiple biasing portions 150. The multiple biasing portions 150 may be in series along the longitudinal axis L1 of the respective arm 120. In some embodiments, multiple arms 130 may extend in parallel between two points along the same path or along different paths. In such embodiments, the different arms 130 may have the same stiffness or different stiffnesses.

In those embodiments where the appliance 100 has two or more arms 130 with biasing portions 150, some, none, or all of the arms 130 may have the same or different lengths, the same or different widths, the same or different thicknesses, the same or different shapes, and/or may be made of the same or different materials, amongst other properties. In some embodiments, less than all of the arms 130 have biasing portions 150. Arms 130 without biasing portions 150 may, for example, comprise one or more rigid connections between the anchor 120 and the attachment portion 140. In some embodiments, none of the arms 130 of the appliance 100 have a biasing portion 150.

The appliances of the present technology may include any number of arms 130 suitable for repositioning the patient's teeth while taking into account the patient's comfort. Unless explicitly limited to a certain number of arms in the specification, the appliances of the present technology may comprise a single arm, two arms, three arms, five arms, ten arms, sixteen arms, etc. In some examples, one, some, or all of the arms 130 of the appliance may be configured to individually connect to more than one tooth (i.e., a single arm 130 may be configured to couple to two teeth at the same time). In these and other embodiments, the appliance 100 may include two or more arms 130 configured to connect to the same tooth at the same time.

Any portion of the appliances of the present technology may include a biasing portion 150. For example, in some embodiments, portion thereof (e.g., the anchor(s), the arm(s), the biasing portion(s), the attachment portion(s), the link(s), etc.) may comprise one or more superelastic materials.

Additional details related to the individual directional force(s) applied via the biasing portion 150 or, more generally the arm 130, are described in U.S. application Ser. No. 15/370,704, now U.S. Pat. No. 10,383,707, issued Aug. 20, 2019, the disclosure of which is incorporated by reference herein in its entirety.

The appliances disclosed herein and/or any portion thereof (e.g., the anchor(s), the arm(s), the biasing portion(s), the attachment portion(s), the link(s), etc.) may comprise one or more superelastic materials. The appliances disclosed herein and/or any portion thereof (e.g., the anchor(s), the arm(s), the biasing portion(s), the attachment portion(s), the link(s), etc.) may comprise Nitinol, stainless steel, beta-titanium, cobalt chrome, MP35N, 35N LT, one or more metal alloys, one or more polymers, one or more ceramics, and/or combinations thereof.

FIGS. 3A and 3B are elevation views of the appliance 100 installed on both the upper and lower arches of a patient's mouth M with the arms 130 coupled to securing members 160 attached to the lingual surfaces of the teeth. It will be appreciated that the appliance 100 of one or both of the upper and lower arches may be positioned proximate a buccal side of a patient's teeth, and that the securing elements 160 and/or arms 130 may alternatively be coupled to the buccal surface of the teeth.

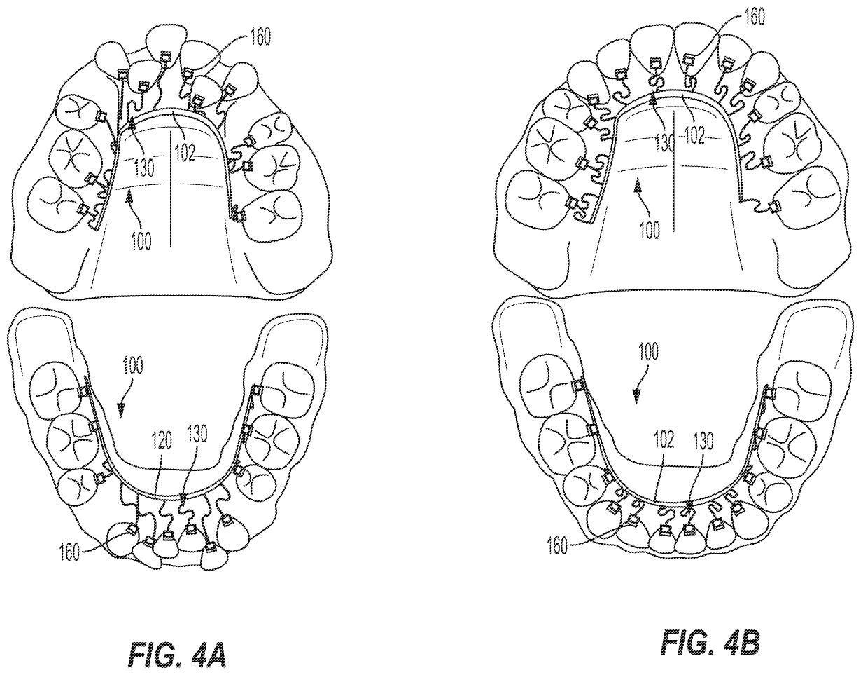

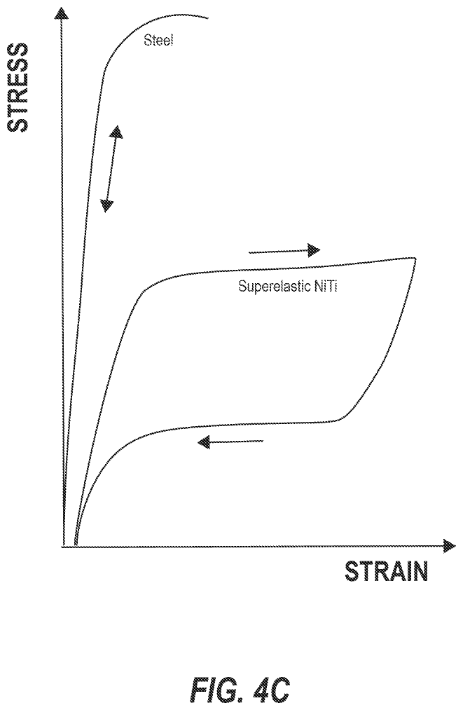

FIG. 4A shows the teeth in an OTA with the arms 130 in a deformed or loaded state, and FIG. 4B shows the teeth in the FTA with the arms 130 in a substantially unloaded state. When the arms 130 are initially secured to the securing members 160 when the teeth are in the OTA, the arms 130 are forced to take a shape or path different than their “as designed” configurations. Because of the inherent memory of the resilient biasing portions 150, the arms 130 impart a continuous, corrective force on the teeth to move the teeth towards the FTA or maintain the teeth in the FTA, which is where the biasing portions 150 are in their as-designed or unloaded configurations. As such, tooth repositioning using the appliances of the present technology can be accomplished in a single step, using a single appliance. In addition to enabling fewer office visits and a shorter treatment time, the appliances of the present technology greatly reduce or eliminate the pain experienced by the patient as the result of the teeth moving as compared to braces. With traditional braces, every time the orthodontist makes an adjustment (such as installing a new archwire, bending the existing archwire, repositioning a bracket, etc.), the affected teeth experience a high force which is very painful for the patient. Over time, the applied force weakens until eventually a new wire is required. The appliances of the present technology, however, apply a movement-generating force on the teeth continuously while the appliance is installed, which allows the teeth to move at a slower rate that is much less painful (if painful at all) for the patient. Even though the appliances disclosed herein apply a lower and less painful force to the teeth, because the forces being applied are continuous and the teeth can move independently (and thus more efficiently), the appliances of the present technology arrive at the FTA faster than traditional braces or aligners, as both alternatives require intermediate adjustments.

In many embodiments, the movement-generating force is lower than that applied by traditional braces. In those embodiments in which the appliance comprises a superelastic material (such as nitinol), the superelastic material behaves like a constant force spring for certain ranges of strain, and thus the force applied does not drop appreciably as the tooth moves. For example, as shown in the stress-strain curves of nitinol and steel in FIG. 4C, the curve for nitinol is relatively flat compared to that of steel. Thus, the superelastic connectors, biasing portions, and/or arms of the present technology apply essentially the same stress for many different levels of strain (e.g., deflection). As a result, the force applied to a given tooth stays constant as the teeth move during treatment, at least up until the teeth are very close or in the final arrangement. The appliances of the present technology are configured to apply a force just below the pain threshold, such that the appliance applies the maximum non-painful force to the tooth (or teeth) at all times during tooth movement. This results in the most efficient (i.e., fastest) tooth movement without pain.

In some embodiments, tooth repositioning may involve multiple steps performed progressively, by using multiple appliances. Embodiments involving multiple steps (or multiple appliances, or both) may include one or more intermediate tooth arrangements (ITAs) between an original tooth arrangement (OTA) and a desired final tooth arrangement (FTA). Likewise, the appliances disclosed herein may be designed to be installed after a first or subsequently used appliance had moved the teeth from an OTA to an ITA (or from one ITA to another ITA) and was subsequently removed. Thus, the appliances of the present technology may be designed to move the teeth from an ITA to an FTA (or to another ITA). Additionally or alternatively, the appliances may be designed to move the teeth from an OTA to an ITA, or from an OTA to an FTA without changing appliances at an ITA. The appliances may additionally or alternatively be configured as a retainer configured to hold the teeth in a desired position.

In some embodiments, the appliances disclosed herein may be configured such that, once installed on the patient's teeth, the appliance cannot be removed by the patient. In some embodiments, the appliance may be removable by the patient.

Any of the example appliances or appliance portions described herein may be made of any suitable material or materials, such as, but not limited to Nitinol (NiTi), stainless steel, beta-titanium, cobalt chrome or other metal alloy, polymers or ceramics, and may be made as a single, unitarily-formed structure or, alternatively, in multiple separately-formed components connected together in single structure. However, in particular examples, the rigid bars, bracket connectors and loop or curved features of an appliance (or portion of an appliance) described in those examples are made by cutting a two dimensional (2D) form of the appliance from a 2D sheet of material and bending the 2D form into a desired 3D shape of the appliance, according to processes as described in U.S. patent application Ser. No. 15/370,704 (Publ. No. 2017/0156823), filed Dec. 6, 2016, or other suitable processes.

### Methods of Manufacturing

The present technology includes methods for designing and fabricating an orthodontic appliance as described herein. The particular processes described herein are exemplary only, and may be modified as appropriate to achieve the desired outcome (e.g., the desired force applied to each tooth by the appliance, the desired material properties of the appliance, etc.). In various embodiments, other suitable methods or techniques can be utilized to fabricate an orthodontic appliance. Moreover, although various aspects of the methods disclosed herein refer to sequences of steps, in various embodiments the steps can be performed in different orders, two or more steps can be combined together, certain steps may be omitted, and additional steps not expressly discussed can be included in the process as desired.

As noted above, in some embodiments an orthodontic appliance is configured to be coupled to a patient's teeth while the teeth are in an OTA. In this position, elements of the appliance exert customized loads on individual teeth to urge them toward a desired FTA or maintain them in the desired FTA. For example, an arm 130 of the appliance 100 can be coupled to a tooth and configured to apply a force so as to urge the tooth in a desired direction toward the FTA. In one example, an arm 130 of the appliance 100 can be configured to apply a tensile force that urges the tooth lingually along the facial-lingual axis. By selecting the appropriate dimensions, shape, shape set, material properties, and other aspects of the arms 130, a customized load can be applied to each tooth to move each tooth from its OTA toward its FTA, or maintain the teeth in the FTA. In some embodiments, the arms 130 are each configured such that little or no force is applied once the tooth to which the arm 130 is coupled has achieves its FTA. In other words, the appliance 100 can be configured such that the arms 130 are at rest in the FTA state.

The method may begin with obtaining data (e.g., position data) characterizing the patient's OTA. In some embodiments the operator may obtain a digital representation of the patient's OTA, for example using optical scanning, cone beam computed tomography (CBCT), scanning of patient impressions, or other suitable imaging technique to obtain position data of the patient's teeth, gingiva, and optionally other adjacent anatomical structures while the patient's teeth are in the original or pre-treatment condition.

The method may further comprise obtaining data (e.g., position data) characterizing the patient's intended or desired FTA, and in many cases generating a digital representation of the patient's FTA. The data characterizing the FTA can include coordinates (e.g., X, Y, Z coordinates) for each of the patient's teeth and the gingiva. Additionally or alternatively, such data can include positioning of each of the patient's teeth relative to other ones of the patient's teeth and/or the gingiva.

In some embodiments, segmentation software (e.g., iROK Digital Dentistry Studio) be used to create individual virtual teeth and gingiva from the OTA data. Suitable software can be used to move the virtual teeth to their FTA positions. In some cases digital models of securing members can be added to the OTA digital model (e.g., by an operator selecting positions on the tooth surface for placement of securing members thereon). Suitable software can be used to move the virtual teeth with the attached securing members from the OTA to a desired final position.

In some embodiments a heat treatment fixture digital model can be obtained. In some embodiments, the heat treatment fixture digital model can correspond to and/or be derived from the FTA digital model. For example, the FTA digital model can be modified (e.g., using MeshMixer or other suitable modeling software) in a variety of ways to render a model suitable for manufacturing a heat treatment fixture. In some embodiments, the FTA digital model can be modified to replace the securing members (which are configured to couple to arms 130 of an appliance 100 (FIG. 3A)) with members (which can be configured to facilitate temporary coupling of the heat treatment fixture to the appliance for shape-setting). Additionally or alternatively, the FTA digital model can be modified to enlarge or thicken the gingiva, to remove one or more of the teeth, and/or to add structural components for increased rigidity. In some embodiments, enlarging or thickening the gingiva may be done to ensure portions (e.g., the anchor) of the fabricated appliance, which is based in part on the FTA digital model, does not engage or contact the patient's gingiva when the appliance is installed. As a result, modifying the FTA digital model as described herein may be done to provide a less painful teeth repositioning experience for the patient.

The method may further comprise obtaining an appliance digital model. As used herein, the term “digital model” and “model” are intended to refer to a virtual representation of an object or collection of objects. For example, the term “appliance digital model” refers to the virtual representation of the structure and geometry of the appliance, including its individual components (e.g., the anchor, arms, biasing portions, attachment portions, etc.). In some embodiments, a substantially planar digital model of the appliance is generated based at least in part on the heat treatment fixture digital model (and/or the FTA digital model). According to some examples, a contoured or 3D appliance digital model generally corresponding to the FTA can first be generated that conforms to the surface and attachment features of the heat treatment fixture digital model. In some embodiments, the 3D appliance digital model can include generic arm portions and securing members, without particular geometries, dimensions, or other properties of the arms being selected or defined by a particular patient. The 3D appliance digital model may then be flattened to generate a substantially planar appliance digital model. In some embodiments, the particular configuration of the arms 130 (e.g., the geometry of biasing portions 150, the position along the anchor 120 (FIG. 3A), etc.) can then be selected so as to apply the desired force to urge the corresponding tooth (to which the arm 130 is attached) from its OTA toward its FTA. As noted previously, in some embodiments the arms are configured so as to be substantially at rest or in a substantially unstressed state when at the FTA. The selected arm configurations can then be substituted or otherwise incorporated into the planar appliance digital model.

In some cases, it may be beneficial to evaluate an intended appliance design prior to fabricating a physical appliance based on the intended appliance design to assess how the physical appliance would perform during treatment. For example, because the pre-installation form of the appliance is based at least in part on a desired FTA, the position of one or more portions of the appliance may shift relative to the gingiva once the physical appliance is installed in the patient's mouth (e.g., with the patient's teeth in the OTA). As a result, one or more shifted positions of the physical appliance may cause pain for the patient that may reduce treatment compliance and/or satisfaction.

In some embodiments, finite element analysis (or other suitable computational techniques) can be used to manipulate the 3D appliance digital model to assess its performance prior to fabrication. For example, the 3D appliance digital model can be virtually deformed (e.g., using finite element analysis) into a position for engagement with the patient's teeth in the OTA. The resulting virtual model represents the appliance digital model after it has been deformed into position to be engaged with the patient's teeth in the OTA. An output of the virtual deformation can be evaluated to assess whether the physical appliance will function as intended. Based on the evaluation of the output, the intended appliance design can be modified as needed, or a final appliance design can be obtained. In some embodiments, a portion of the appliance digital model may impinge on the gingiva digital model. As a result, the design of the appliance may be modified, and the evaluation may be repeated until the appliance digital model no longer impinges on the gingiva. This process may be repeated iteratively until a satisfactory appliance design is achieved.

Next, the heat treatment fixture can be fabricated. For example, using the heat treatment fixture digital model, the heat treatment fixture can be cast, molded, 3D printed, or otherwise fabricated using suitable materials configured to withstand heating for shape setting of an appliance thereon.

In some embodiments, fabricating the appliance includes first fabricating the appliance in a planar configuration based on the planar appliance digital model. For example, a pattern of the planar form of the final device can be cut out of a sheet of material to get a planar member. In some embodiments, the appliance is cut out of a sheet of Nitinol or other metal using laser cutting, water jet, stamping, or other suitable technique. The thickness of the material can be varied across the appliance, for example by electropolishing, etching, depositing, or otherwise manipulating the material of the appliance to achieve the desired material properties.

According to some embodiments, the planar member (e.g., as 3D-printed or as cut out from a sheet of material) can be bent or otherwise manipulated into the desired arrangement (e.g., substantially corresponding to the FTA) to form a 3D appliance for treatment. In some embodiments, the planar member can be bent into position by coupling the planar member to a heat treatment fixture. The heat treatment fixture may be, for example, the physical form of the previously-obtained heat treatment fixture digital model. For example, the arms of the planar member can be removably coupled to hook members of the heat treatment fixture, and optionally ligature wire or other temporary fasteners can be used to secure the arms or other portions of the appliance to the heat treatment fixture. The resulting assembly (i.e., the appliance fastened to the heat treatment fixture) can then be heated to shape-set the appliance into its final form, which can correspond or substantially correspond to the FTA. As a result, the appliance is configured to be in an unstressed state in the FTA. The shape set appliance can then be removed from the heat treatment fixture.

In operation, the appliance can then be installed in the patient's mouth (e.g., by bending or otherwise manipulating arms of the appliance to be coupled to brackets of the patient's teeth while in the OTA). Due to the shape set of the appliance and the geometry of the arms and anchor, the arms will tend to urge each tooth away from its OTA and toward the FTA.

### III. Selected Examples of Orthodontic Appliance Configurations

The appliances of the present technology (including any of the retainers described herein) may comprise any combination of structural elements to directly or indirectly couple a first tooth (or teeth) to a second tooth (or teeth) and/or another anatomical structure or location within or proximate the oral cavity. The particular configuration may be selected based on one or more desired functional characteristics, such as flexibility, bias force magnitude, bias force direction, durability, and others. FIGS. 5-10 depict several examples of configurations for use with the appliances of the present technology. Although each configuration is explained with reference to two attachment portions 140, the appliances of the present technology may have any number of attachment portions.

As shown in FIG. 5, the appliance 100 may include one or more connection configurations comprising a first connector 106a extending gingivally from a first attachment portion 140a, a first connector 106b extending gingivally from a second attachment portion 140b, and a third connector 108 extending between the gingival end portions of the first connectors 106a, 106b. The attachment portions 140a, 140b are not connected by a first connector 104. In FIG. 6, all three of the connectors 106a, 106b, and 108 are generally linear, have a relatively large width w, and do not include any biasing portions. As a result, each of the connectors 106a, 106b, and 108 comprises a rigid connector (i.e., having an infinite stiffness coefficient k) such that the first and second teeth T1, T2 will not move relative to one another.

The attachment portions 140a, 140b utilized in a given connection configuration may have the same or different shape, size, and/or configuration, and may comprise any of the attachment portions, bracket connectors, and/or male connector elements disclosed herein, as well as any of the attachment portions, bracket connectors, and/or male connector elements disclosed in U.S. Pat. No. 10,383,707, filed Dec. 6, 2016, which is incorporated by reference herein in its entirety. Likewise, the appliance carrying the attachment portions 140a, 140b may be any of the appliances disclosed herein, as well as any of the appliances disclosed in U.S. Pat. No. 10,383,707, filed Dec. 6, 2016.

As shown in FIG. 6, the appliance 100 may include one or more connection configurations comprising a second connector 106a extending gingivally from a first attachment portion 140a, a second connector 106b extending gingivally from a second attachment portion 140b, and a third connector 108 extending between the gingival end portions of the first and second connectors 106a, 106b. The attachment portions 140a, 140b are not connected by a first connector 104. In FIG. 6, the second connectors 106a, 106b are generally linear, have a relatively large width w, and do not include any biasing portions. As a result, each of the second connectors 106a, 106b comprise a rigid connector (i.e., having an infinite stiffness coefficient k). The first connector 104, however, has a smaller width and two biasing portions 150 along its longitudinal axis. As a result, the first connector 104 has a positive, non-zero stiffness coefficient. Each of the biasing portions 150 comprise an open loop/U-shaped portion of the first connector 104 that extends in a generally occlusal direction such that each of the biasing portions 150 has a concave portion that faces in a gingival direction.

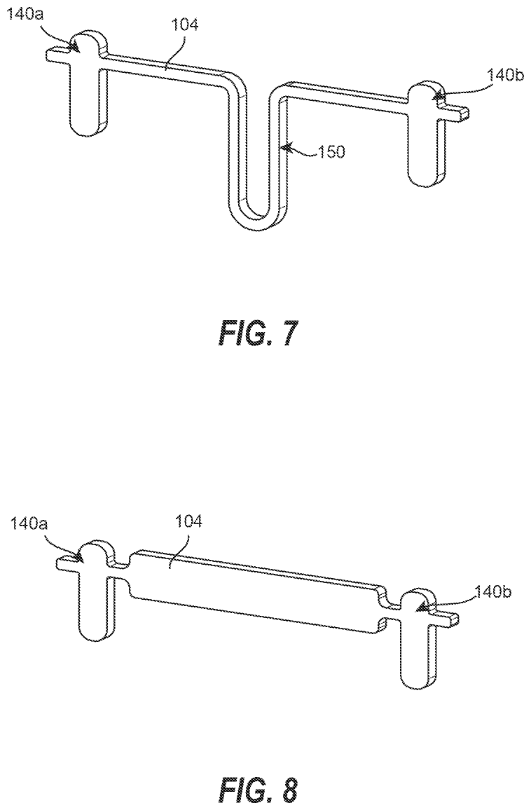

As shown in FIG. 7, the appliance 100 may include one or more connection configurations comprising a first connector 104 having a biasing portion 50 such that the first connector 104 has a non-zero, positive stiffness coefficient. As a result, the first connector 104 is relatively flexible and allows for movement between the first and second teeth T1, T2. The connection configuration of FIG. 7 does not include any second connectors or third connectors, and thus the attachment portions 140a, 140b (and associated teeth) are connected only by the first connector 104.

As shown in FIG. 8, in some embodiments, the appliance 100 may include one or more connection configurations comprising a first connector 104 that is generally rigid, for example as shown in FIG. 8. The first connector 104 does not have a biasing portion and has a relatively larger width. In contrast to the configuration of FIG. 7, the first connector 104 of FIG. 8 does not allow for relative movement between the teeth. Such a configuration may be beneficial, for example, when moving two or more teeth as a group, or when two or more teeth do not require any movement between the OTA and the FTA and so can be used to help anchor the anchor.

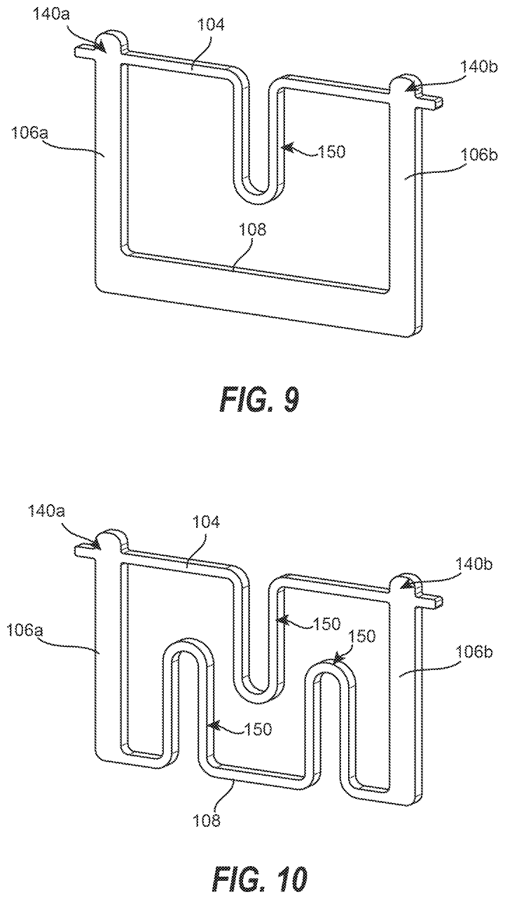

As shown in FIG. 9, the appliance 100 may include one or more connection configurations comprising a second connector 106a extending gingivally from a first attachment portion 140a, a second connector 106b extending gingivally from a second attachment portion 140b, a third connector 108 extending between the gingival end portions of the second connectors 106a, 106b, and a first connector 104 extending between the first and second attachment portions 140a, 140b. In FIG. 9, the second connector 106a, the second connector 106b, and the third connector 108 are generally linear, have a relatively large width w, and do not include any biasing portions. As a result, each of the connectors 106a, 106b, and 108 comprises a rigid connector (i.e., having an infinite stiffness coefficient k). The first connector 104 includes a single biasing portion 50 and thus has a non-zero, positive stiffness coefficient. However, the overwhelming rigidity provided by the second connector 106a, second connector 106b, and third connector 108 dictates that the first and second teeth T1, T2 will not move relative to one another.

As shown in FIG. 10, the appliance 100 may include one or more connection configurations comprising a second connector 106a extending gingivally from a first attachment portion 140a, a second connector 106b extending gingivally from a second attachment portion 140b, a third connector 108 extending between the gingival end portions of the second connectors 106a, 106b, and a first connector 104 extending between the first and second attachment portions 140a, 140b. In FIG. 10, the second connector 106a and the second connector 106b are generally linear, have a relatively large width w, and do not include any biasing portions. As a result, each of the connectors 106a, 106b comprises a rigid connector (i.e., having an infinite stiffness coefficient k). The first connector 104 includes a single biasing portion 50 and thus has a non-zero, positive stiffness coefficient, and the third connector 108 includes two biasing portions 150 in series and thus also has a non-zero, positive stiffness coefficient.

### IV. Selected Retainers and Associated Devices, Systems, and Methods

After a patient's teeth have reached a desired position (such as an FTA), typically the orthodontic appliance, brackets, and any other previously-installed orthodontic devices are removed from the patient's mouth. Without the correcting forces of the orthodontic appliance, the teeth can shift or twist out of alignment over time. In order to prevent this movement, or to make minor corrections to tooth placement, an orthodontist will typically provide the patient with a removable retainer.

Successful retention (and thus successful orthodontic treatment) depends entirely on the cooperation of the patient, as the patient has the choice of wearing or not wearing the retainer. However, despite continued advancements in orthodontic technology, patient compliance with retainers remains a significant concern. Approximately 50% of patients openly admit to not complying with their orthodontist's instructions on how to properly wear orthodontic retainers. Forgetting to wear a retainer is a leading reason for poor compliance, along with discomfort, the hassle of wearing a device, and speech difficulties. Depending on the degree of the patient's noncompliance, the teeth may relapse out of alignment enough that the retainer no longer fits over the patient's teeth. In these cases, retreatment with braces is usually required to correct the teeth.

In an attempt to address compliance issues, a common solution is to fit the patient with a bonded or fixed retainer. Such retainers typically comprise a wire running along a lingual surface of the patient's teeth. Successful retention for fixed retainers relies on patient compliance in maintaining optimal hygiene and care over long periods of time. However, because the fixed retainers extend across adjacent teeth, the patient is prevented from traditional flossing.

An orthodontic appliance in accordance with several embodiments of the present technology can be configured to be installed in a patient's mouth as a permanent retainer at the completion of a treatment (i.e., when the teeth are in the FTA) to generally maintain the position of the teeth in the FTA. In these and other embodiments, an orthodontic appliance of the present technology can be configured for installation at the beginning of or during treatment to reposition one or more of the patient's teeth and be configured to remain installed in the patient's mouth as a permanent retainer. Using the same device for the initial treatment and retention obviates at least one office visit by the patient and is less expensive than using both an orthodontic appliance and a separate retainer.

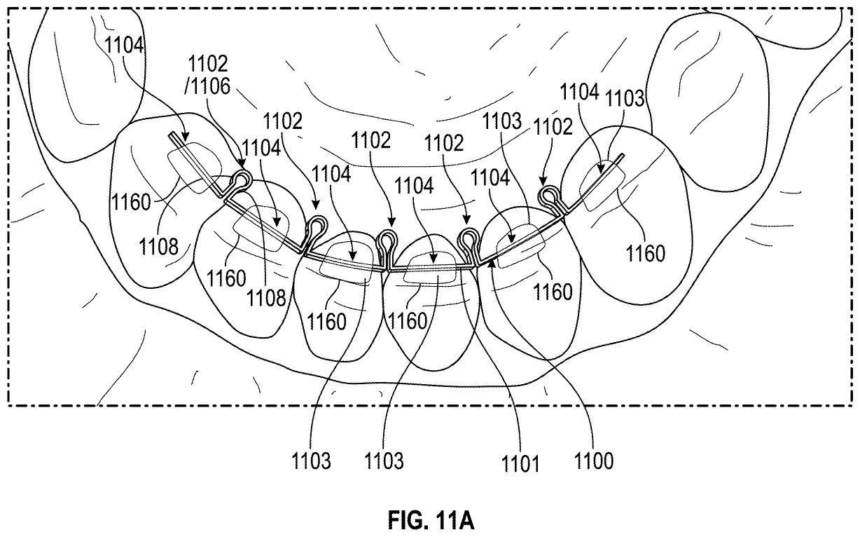

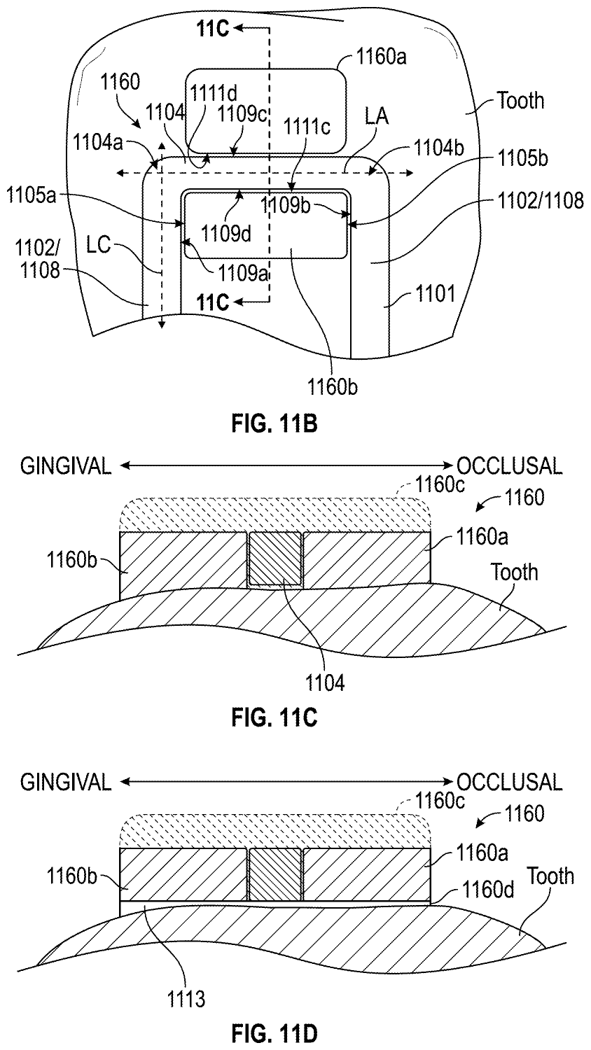

FIG. 11A shows an orthodontic appliance 1100 (or “the appliance 1100”) configured for use as a) a temporary appliance for repositioning a patient's teeth into a desired ITA or FTA, b) a permanent retainer for maintaining a patient's teeth in the ITA or FTA, and c) both as an appliance for repositioning a patient's teeth and as a permanent retainer for maintaining a position of the patient's teeth. The appliance 1100 is configured to be secured to a lingual or buccal surface of a patient's teeth via one or more securing members. The appliance 1110 is configured to engage the securing member(s) in such a way that resists or substantially inhibits mesiodistal movement of the appliance 1100 relative to the patient's dentition, thereby enabling the appliance 1100 to apply a force to the tooth to resist or encourage movement.

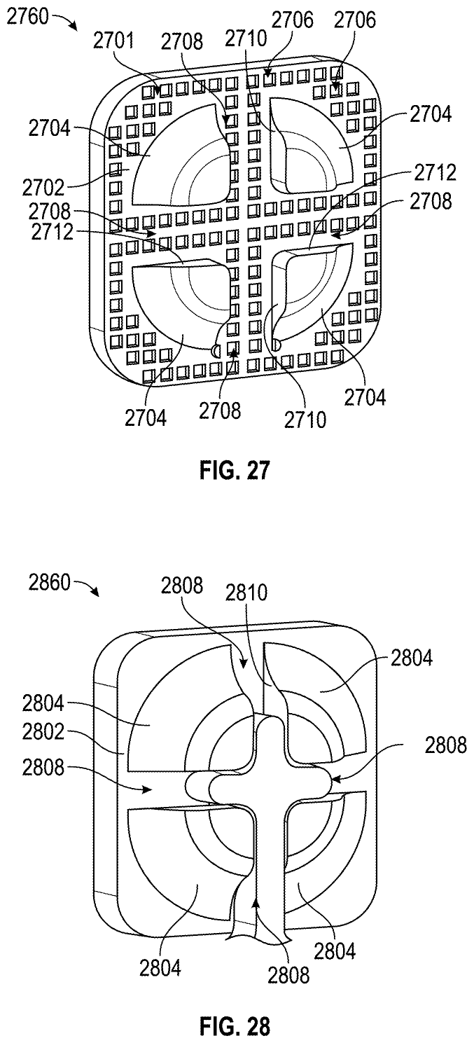

In some embodiments, the appliance 1100 is configured to be secured to a lingual or buccal surface of the patient's teeth without the use of traditional brackets. For example, the appliance 1100 can be configured to be secured to the patient's teeth via a securing member 1160 formed partially or entirely of a composite material 1103. Use of a composite material in lieu of all or part of a traditional bracket can be more comfortable for the patient as the composite material presents a smoother lingual or buccal surface to the patient (depending on the side of the tooth to which the securing member is secured) and allows the securing member 1160 to have a lower profile than a traditional bracket. In some embodiments, for example as shown in FIG. 11A, the securing member 1160 can be entirely formed of a cured or curable composite material and does not rely on any rigid and/or metal components to support and/or retain the corresponding attachment portion. In some embodiments, the appliance 1100 can be secured to a patient's teeth via one or more securing members comprising both a bracket portion and a composite portion (referred to herein as a “hybrid bracket”). As described in greater detail herein, including with respect to FIGS. 27-32, the bracket portions of the hybrid brackets of the present technology do not extend over a lingual or buccal surface of the appliance (depending on the side of the tooth to which the securing member is positioned) to help hold the appliance in place. Instead, the composite portion of the hybrid bracket is configured to be disposed over the attachment portion and the bracket portion, thereby securing the attachment portion to the hybrid bracket. According to some examples, the appliance 1100 can be configured to be secured to the teeth via securing members comprising brackets and without any composite material.

The appliance 1100 may comprise an elongated member 1101 configured to be positioned along the patient's dental arch. The elongated member 1101 can have alternating connectors 1102 and attachment portions 1104 along its longitudinal axis. In some embodiments, the elongated member 1101 is a single, monolithic structure such that the connectors 1102 and the attachment portions 1104 are integral and/or continuous with one another. To achieve such a structure, in some embodiments the elongated member 1101 is cut from a sheet of material (for example, as detailed above). In some embodiments, the elongated member 1101 can be formed by other suitable methods including, for example, molding, casting, machining, 3D printing, stamping, extruding, or the like. The elongated member 1101 may comprise a metal or a plastic and may have superelastic and/or shape memory properties. In some embodiments, the elongated member 1101 does not have superelastic and/or shape memory properties.

The elongated member 1101 can have a first side configured to be positioned against a lingual or buccal surface of the teeth, a second side facing away from the teeth, and a thickness measured between the first and second sides. In some embodiments, the elongated member 1101 has a substantially constant thickness along its longitudinal axis, and in some embodiments the elongated member 1101 has a varying thickness along its longitudinal axis. In accordance with several aspects of the technology, the elongated member 1101 comprises a wire having a round, square, or rectangular cross-section with a substantially constant cross-sectional dimension along its longitudinal axis. In some embodiments the elongated member 1101 comprises a wire having a round, square, or rectangular cross-section with a varying cross-sectional dimension along its longitudinal axis. According to some embodiments, the elongated member 1101 is a wire having a substantially circular cross-sectional shape.

FIG. 11B is an enlarged view of a portion FIG. 11A, showing one of the attachment portions 1104 and securing members 1160, as well as portions of the connectors 1102 extending from either side of the attachment portion 1104. In FIG. 11B, an outermost portion of the composite material 1103 (i.e., farthest from the tooth) has been removed to more clearly view the underlying attachment portion 1104. To further clarify, FIG. 11C is a cross-sectional side view taken along line 11C-11C in FIG. 11B. As shown in FIG. 11C, the securing member 1160 is configured to be positioned on either side of the attachment portion 1104. The securing member 1160, for example, can have a first portion 1160a positioned at an occlusal side of the attachment portion 1104 and a second portion 1160b positioned at a gingival side of the attachment portion 1104. A third portion 1160c of the securing member 1160, which is shown in dashed lines as it has been removed in FIG. 11B (but still visible in FIG. 11A) extends over the attachment portion 1104 and first and second portions 1160a, 1160b. In those embodiments in which the securing member 1160 is formed entirely of a composite material, the first, second, and third portions 1160a-c comprise a composite material. In some methods of use, the attachment portion 1104 can be held in a desired location on the tooth, and the first, second, and third portions 1160a-c can be deposited on and around the attachment portion 1104 (and in some cases on and around nearby regions of the appliance 1100) and cured in place. As depicted in FIG. 11D, according to some methods, an initial layer 1113 of composite material is first deposited on the surface of the tooth, and the attachment portion 1104 is then positioned on the layer 1113 and the first, second, and third portions 1160a-c are deposited and cured.

As shown in FIGS. 11A and 11B, the individual attachment portions 1104 may be configured to extend along a lingual or buccal surface of an individual tooth when the appliance 1100 is installed. In some embodiments, one, some, or all of the attachment portions 1104 comprise a substantially rigid member that extends along a generally mesiodistal dimension when the appliance is installed in the patient's mouth. The individual attachment portions 1104 may comprise a substantially linear segment of the elongated member 1101 (as shown in FIG. 11B), or may be curved along all or a portion of their lengths. As described in greater detail herein, one or more surfaces of the attachment portion 1104 and adjacent portions of the connectors 1102 can be configured to abut the first and/or second portions 1160a, 1160b of the securing member to prevent or substantially inhibit movement of the appliance 1100 along an occlusogingival and/or mesiodistal dimension.

One, some, or all of the connectors 1102 may extend gingivally away from the attachment portions 1104 to which the corresponding connector 1102 is attached. In some embodiments, one, some, or all of the connectors 1102 extend occlusally away from the attachment portions 1104 to which the corresponding connector 1102 is attached. In some embodiments, one, some, or all of the connectors 1102 have a first end portion that extends occlusally away from the attachment portion 1104 to which it is attached and a second end portion that extends gingivally away from the attachment portion 1104 to which it is attached.

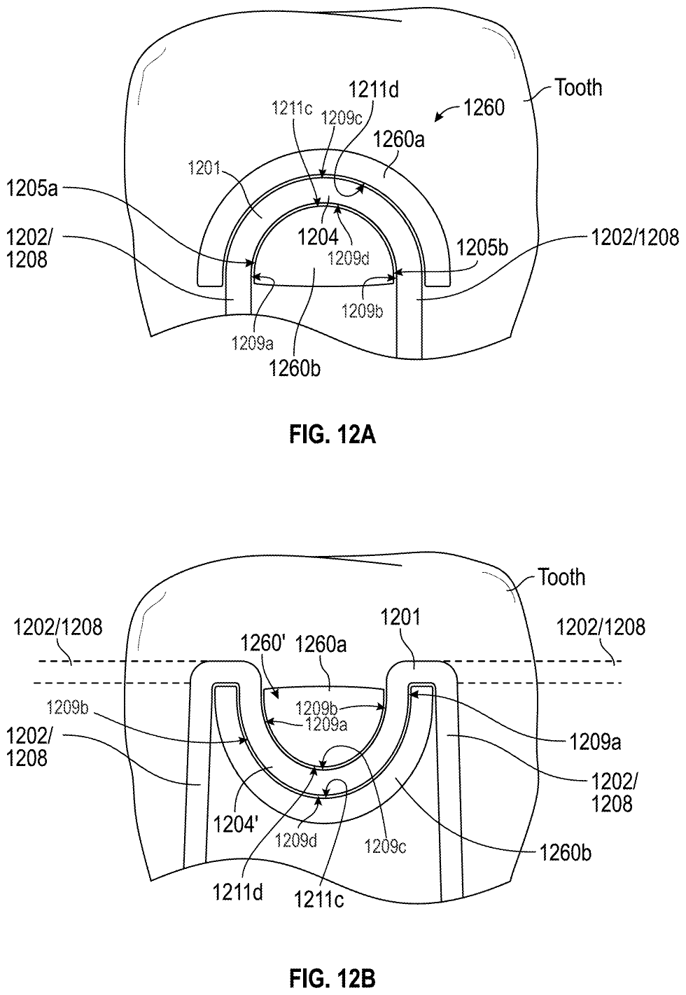

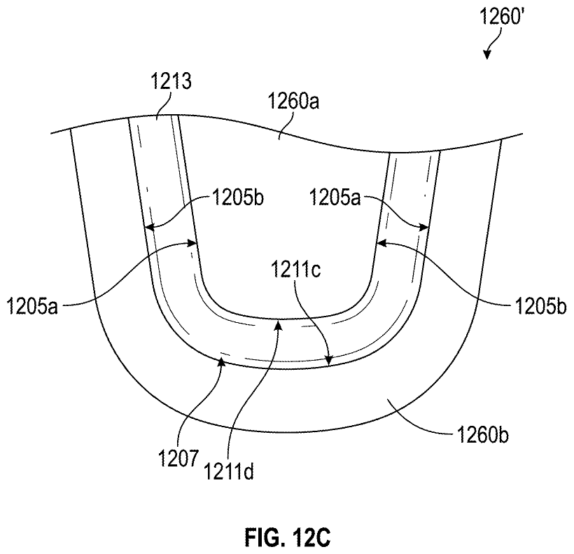

Each of the connectors 1102 can comprise first and second legs 1108, each extending generally along an occlusogingival dimension when the appliance is installed, and at least one mesiodistal portion 1106 extending between the legs 1108. One, some, or all of the attachment portions 1104 of the appliance 1100 can have a first or mesial end portion coupled to and/or continuous with a first leg 1108 of a first connector 1102 and a second or distal end portion coupled to and/or continuous with a second leg 1108 of a second connector 1102. One, some, or all of the first legs 1108 can be substantially linear or curved, and one, some, or all of the second legs 1108 can be substantially linear or curved. Likewise, one, some, or all of the mesiodistal portions 1106 can be linear or curved. In those embodiments where all or a portion of a given connector 1102 is curved, the connector 1102 may be relatively flexible and comprise a biasing portion, as detailed herein. In some embodiments, one, some, or all of the connectors may extend directly between adjacent attachment portions 1104 along a substantially linear path. Such connectors can be substantially rigid and allow little or no movement between the adjacent attachment portions 1104. As shown in FIGS. 11A and 11B, the connectors 1102 can be generally U-shaped. Other shapes are possible, including any of the connectors and biasing portions discussed above with respect to FIGS. 3A-10 and discussed below with respect to FIGS. 12A-24.

Mesiodistal movement of the individual attachment portions 1104 may be limited or substantially inhibited by the interaction between one or both of the legs 1108 and the adjacent surface of the securing member 1160. For example, as shown in FIG. 11B, the appliance 1100 may be positioned in the mouth such that (a) a mesial-facing surface 1105a of the securing member 1160 abuts a distal-facing surface 1109a of the adjacent leg 1108 and/or connector 1102 and prevents distal movement of that leg 1108 and/or connector 1102, and/or (b) a distal surface 1105b of the securing member 1160 abuts a mesial surface 1109b of the adjacent leg 1108 and/or connector 1102 and prevents mesial movement of that leg 1108 and/or connector 1102. One or both of the legs 1108 connected to a given attachment portion 1104 may form an angle with the attachment portion 1104 of about 90 degrees, an acute angle, or an obtuse angle (where the acute or obtuse angle is measured on the gingival side of the joint). The angle can be measured between a longitudinal axis LA of the attachment portion 1104 and a longitudinal axis LC of the connector 1102 and/or leg 1108.

Occlusogingival movement of the individual attachment portions 1104 may be limited or substantially inhibited by the interaction between the attachment portion 1104 and the adjacent surface of the securing member 1160. For example, as shown in FIG. 11B, the appliance 1100 may be positioned in the mouth such that (a) an occlusally-facing surface 1111c of the securing member 1160 abuts a gingivally-facing surface 1109d of the attachment portion 1104 and prevents gingival movement of the attachment portion 1104, and/or (b) a gingivally-facing surface 1111d of the securing member 1160 abuts an occlusally-facing surface 1109c of the attachment portion 1104 and prevents occlusal movement of the attachment portion 1104.

The appliance 1100 may be configured to be bonded directly to the patient's teeth (i.e., without the use of a securing member) such that the patient cannot remove the appliance 1100. The appliance 1100 may be configured to be positioned such that the connectors 1102 are aligned with the mesial and distal surfaces of adjacent teeth (i.e., where adjacent teeth meet) and the more linear segments extend in a generally mesiodistal direction along the surface of the tooth between curved segments 1102. Positioning the curved segments between the teeth such that the U-shaped portions dip towards the gingiva advantageously allows the patients to floss. The U-shaped portion may also be relatively compliant such that forces can be applied to adjacent teeth. In some embodiments, the curved segments are flexible while the more linear segments are rigid. Other configurations are possible.

While the first and second portions 1160a, 1160b shown in FIG. 11B comprise a composite material, in some embodiments one or both of the first and second portions 1160a, 1160b can comprise a metal or other non-curable material. In such embodiments, a curable composite material may still be deposited over the first and second portions 1160a, 1160b, gap between the first and second portions 1160a, 1160b, and the attachment portion 1104. In several of such embodiments, first and/or second portions 1160a, 1160b can positioned on and/or integral with a backing, for example as shown in securing members 2760, 2860, 2960 and 3060.

FIG. 12A shows an enlarged view of a portion of an appliance secured to a securing member 1260. In FIG. 12A, the portion of the appliance shown is a single attachment portion 1204 and portions of the connectors 1202 extending from either side of the attachment portion 1204. In some embodiments, including that shown in FIG. 12A, the securing member 1260 is formed entirely of a curable composite material 1203. As with FIG. 11B, an outermost portion of the composite material 1203 (i.e., farthest from the tooth) has been removed to more clearly view the underlying attachment portion 1204.

In contrast to the attachment portion 1104 shown in FIGS. 11A and 11B, the attachment portion 1204 shown in FIG. 12A curves continuously along its longitudinal axis, thus requiring a securing member with a different shape than that of securing member 1160. The securing member 1260 can have a first portion 1260a positioned at an occlusal side of the attachment portion 1204 and a second portion 1260b positioned at a gingival side of the attachment portion 1204. A third portion of the securing member 1260 (not shown) would extend over the attachment portion 1204 and first and second portions 1260a, 1260b. In those embodiments in which the securing member 1260 is formed entirely of a composite material, the first, second, and third portions comprise a composite material. In some methods of use, the attachment portion 1204 can be held in a desired location on the tooth, and the first, second, and third portions can be deposited on and around the attachment portion 1204 (and in some cases on and around nearby regions of the appliance 1200) and cured in place. According to some methods, an initial layer 1213 of composite material is first deposited on the surface of the tooth, and the attachment portion 1204 is then positioned on the layer and the first, second, and third portions are deposited and cured.

As described herein, one or more surfaces of the attachment portion 1204 and adjacent portions of the connectors 1202 can be configured to abut the first and/or second portions 1260a, 1260b of the securing member to prevent or substantially inhibit movement of the appliance along an occlusogingival and/or mesiodistal dimension. For example, mesiodistal movement of the individual attachment portions 1204 may be limited or substantially inhibited by the interaction between one or both of the legs 1208 (a curved and/or linear portion) and the adjacent surface of the securing member 1260. For example, as shown in FIG. 12A, the appliance may be positioned in the mouth such that (a) a mesial-facing surface 1205a of the securing member 1260 abuts a distal-facing surface 1209a of the adjacent leg 1208 and/or connector 1202 and prevents distal movement of that leg 1208 and/or connector 1202, and/or (b) a distal surface 1205b of the securing member 1260 abuts a mesial surface 1209b along a gingival side of the adjacent leg 1208 and/or connector 1202 and prevents mesial movement of that leg 1208 and/or connector 1202. One or both of the legs 1208 connected to a given attachment portion 1204 may form an angle with the attachment portion 1204 of about 90 degrees, an acute angle, or an obtuse angle (where the acute or obtuse angle is measured on the gingival side of the joint). The legs 1208 may be generally parallel to one another (as shown in FIG. 12A) and/or angled relative to one another.

Occlusogingival movement of the individual attachment portions 1204 may be limited or substantially inhibited by the interaction between the attachment portion 1204 and the adjacent surface of the securing member 1260. For example, as shown in FIG. 12A, the appliance may be positioned in the mouth such that (a) an occlusally-facing surface 1211c of the securing member 1260 abuts a gingivally-facing surface 1209d of the attachment portion 1204 and prevents gingival movement of the attachment portion 1204, and/or (b) a gingivally-facing surface 1211d of the securing member 1260 abuts an occlusally-facing surface 1209c of the attachment portion 1204 and prevents occlusal movement of the attachment portion 1204.

While the first and second portions 1260a, 1260b shown in FIG. 12A comprise a composite material, in some embodiments one or both of the first and second portions 1260a, 1260b can comprise a metal or other non-curable material. In such embodiments, a curable composite material may still be deposited over the first and second portions 1260a, 1260b, gap between the first and second portions 1260a, 1260b, and the attachment portion 1204. In several of such embodiments, first and/or second portions 1260a, 1260b can positioned on and/or integral with a backing, for example as shown in securing members 2760, 2860, 2960 and 3060.

FIG. 12B shows an enlarged view of a portion of an appliance secured to a securing member 1260′. The securing member 1260′ is shown isolated from the attachment portion 1204′ and tooth in FIG. 12C. In FIG. 12B, the portion of the appliance shown is a single attachment portion 1204′ and portions of the connectors 1202 extending from either side of the attachment portion 1204′. In some embodiments, including that shown in FIG. 12B, the securing member 1260′ is a hybrid bracket comprising a bracket portion (shown in FIG. 12C) and a composite portion. As with FIG. 11B, the outer composite material 1203 (i.e., farthest from the tooth) has been removed to more clearly view the underlying attachment portion 1204′.

In contrast to the attachment portions 1104 and 1204 shown in FIGS. 11B and 12A, respectively, the attachment portion 1204′ shown in FIG. 12B forms a curve that is concave in an occlusal direction. As such, the securing member 1260′ can inhibit movement of the attachment portion 1204′ without the connectors 1202 and/or legs 1208. For example, the securing member 1260′ can be used with appliances of the present technology in which the connectors 1202 and/or legs 1208 extend away from the attachment portion 1204′ along a generally mesiodistal dimension (as indicated in dashed lines). The securing member 1260′ can comprise a backing 1213 and first and second portions 1260a, 1260b continuous with and extending away from the backing 1213 along a buccolingual dimension. The first and second portions 1260a, 1260b can be spaced apart by a gap 1207.

As shown in FIG. 12B, the first portion 1260a can be configured to be positioned at an occlusal side of the attachment portion 1204′ and the second portion 1260b can be configured to be positioned at a gingival side of the attachment portion 1204′. When the securing member 1260′ is secured to the tooth and the attachment portion 1204′ is received within the gap 1207, a curable composite material can be deposited over the attachment portion 1204′, gap 1207, and first and second portions 1260a, 1260b, thereby securing the attachment portion 1204′ to the securing member 1260′ without any portion of the bracket portion extending over a lingual (or buccal) surface of the attachment portion 1204′.

As described herein, one or more surfaces of the attachment portion 1204′ can be configured to abut the first and/or second portions 1260a, 1260b of the securing member 1260′ to prevent or substantially inhibit movement of the appliance along an occlusogingival and/or mesiodistal dimension. For example, mesiodistal movement of the individual attachment portions 1204′ may be limited or substantially inhibited by the interaction between an occlusogingivally-extending portion of the attachment portion 1204′ and the adjacent surface of the securing member 1260′. For example, as shown in FIGS. 12B and 12C, the appliance may be positioned in the mouth such that (a) a mesial-facing surface 1205a (only labeled in FIG. 12C) of the securing member 1260′ abuts a distal-facing surface 1209a of the attachment portion 1204′ and prevents distal movement of the attachment portion 1204′, and/or (b) a distal surface 1205b of the securing member 1260′ abuts a mesial surface 1209b along the gingival side of the attachment portion 1204′ and prevents mesial movement of the attachment portion 1204′. Moreover, a mesial surface 1209b along the occlusal side of the attachment portion 1204′ opposes a mesial-facing surface 1205b of the first portion 1260a of the securing member 1260′ and a distal-facing surface 1209a along a gingival side of the attachment portion 1204′ opposes a distal-facing surface 1205a of the first portion 1260a of the securing member 1260′.

It will be appreciated that for any of the mesial/distal orientations used herein with reference to any figure, whether the direction is “mesial” or “distal” depends on which side of the midline of the jaw the referenced portion is positioned on. As such, as used herein, a “mesial-facing surface” could also be a “distal-facing surface,” and vice versa, if the portion is positioned on the opposite side of the jaw.

Occlusogingival movement of the individual attachment portions 1204′ may be limited or substantially inhibited by the interaction between the attachment portion 1204′ and the adjacent surface of the securing member 1260′. For example, as shown in FIGS. 12B and 12C, the appliance may be positioned in the mouth such that (a) an occlusally-facing surface 1211c of the securing member 1260′ abuts a gingivally-facing surface 1209d of the attachment portion 1204′ and prevents gingival movement of the attachment portion 1204′, and/or (b) a gingivally-facing surface 1211d of the securing member 1260′ abuts an occlusally-facing surface 1209c of the attachment portion 1204′ and prevents occlusal movement of the attachment portion 1204′.

FIG. 13A illustrates an orthodontic appliance 1300 (“appliance 1300”) configured in accordance with several embodiments of the present technology, shown installed in a patient's mouth adjacent the patient's dentition. As depicted in FIG. 13A, the appliance 1300 may be configured to be secured to a lingual surface of the patient's teeth via a securing member comprising a composite material 1303. In some embodiments, the appliance 1300 may be configured to be secured to a buccal surface of the patient's teeth, and/or may be configured to be secured to the teeth via one or more brackets. The appliance 1300 may be configured to be installed as a permanent retainer at the completion of a treatment (i.e., when the teeth are in the FTA) to generally maintain the position of the teeth in the FTA, or may be configured for installation at the beginning or during treatment to reposition one or more of the patient's teeth, or may be configured to first reposition the patient's teeth and then retain the patient's teeth in a desired position. As discussed in greater detail below, the appliance 1300 may be configured to engage a corresponding securing member (e.g., a composite material or a bracket) in such a way that resists or inhibits mesiodistal movement of the appliance 1300 relative to the patient's dentition, thereby enabling the appliance 1300 to apply a force to the tooth to resist or encourage movement.

The appliance 1300 may comprise an elongated member 1301 configured to be positioned along the patient's dental arch. The elongated member 1301 can have alternating connectors 1302 and attachment portions 1304 along its longitudinal axis. In some embodiments, the elongated member 1301 is a single, monolithic structure such that the connectors 1302 and the attachment portions 1304 are integral and/or continuous with one another. To achieve such a structure, in some embodiments the elongated member 1301 is cut from a sheet of material (for example, as detailed above). In some embodiments, the elongated member 1301 can be formed by other suitable methods including, for example, molding, casting, machining, 3D printing, stamping, extruding, or the like. The elongated member 1301 may comprise a metal or a plastic and may have superelastic and/or shape memory properties. In some embodiments, the elongated member 1301 does not have superelastic and/or shape memory properties.

The elongated member 1301 can have a first side configured to be positioned against a lingual or buccal surface of the teeth, a second side facing away from the teeth, and a thickness measured between the first and second sides. In some embodiments, the elongated member 1301 has a substantially constant thickness along its longitudinal axis, and in some embodiments the elongated member 1301 has a varying thickness along its longitudinal axis. In accordance with several aspects of the technology, the elongated member 1301 comprises a wire having a round, square, or rectangular cross-section with a substantially constant cross-sectional dimension along its longitudinal axis. In some embodiments the elongated member 1301 comprises a wire having a round, square, or rectangular cross-section with a varying cross-sectional dimension along its longitudinal axis.

The individual attachment portions 1304 may extend along a lingual or buccal surface of an individual tooth when the appliance 1300 is installed, and may be secured to a corresponding tooth via a securing member, such as a composite material 1303 as shown in FIG. 13B. In FIG. 13B, a line has been drawn around the periphery of the substantially transparent composite material to help visualize placement of the composite material relative to the attachment portion 1304. The portion of the elongated member 1301 between the tooth and the composite material (i.e., under the composite material) is shown in dashed lines.

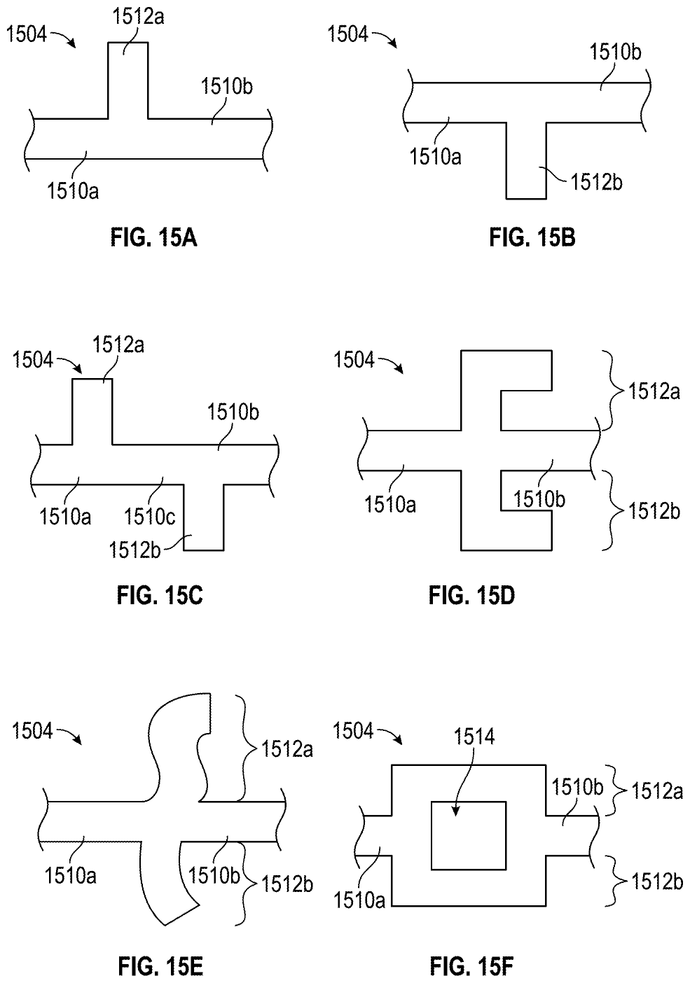

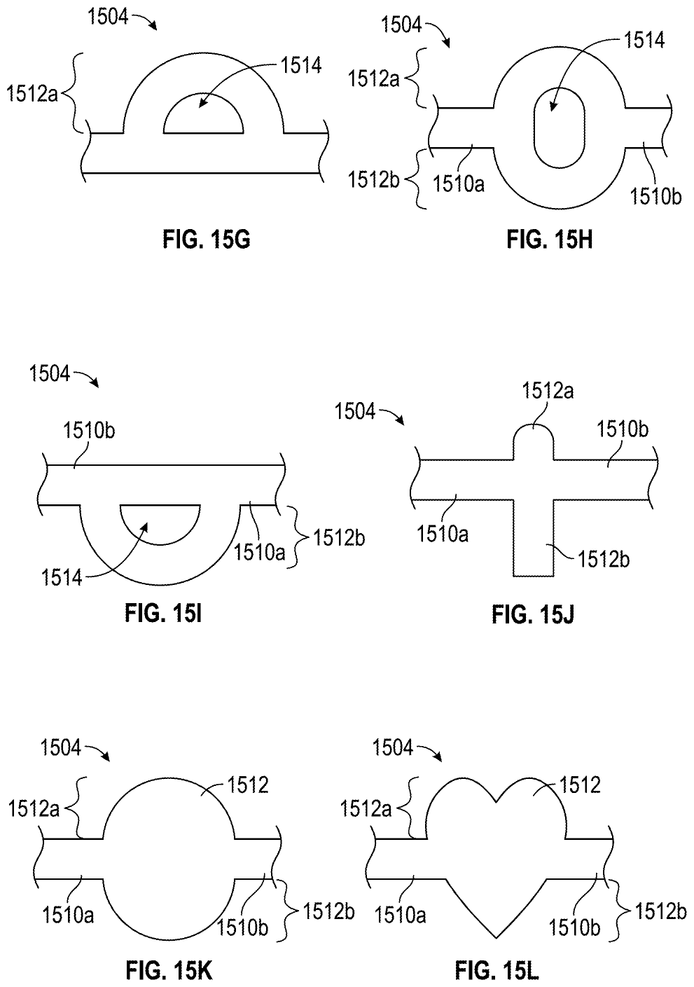

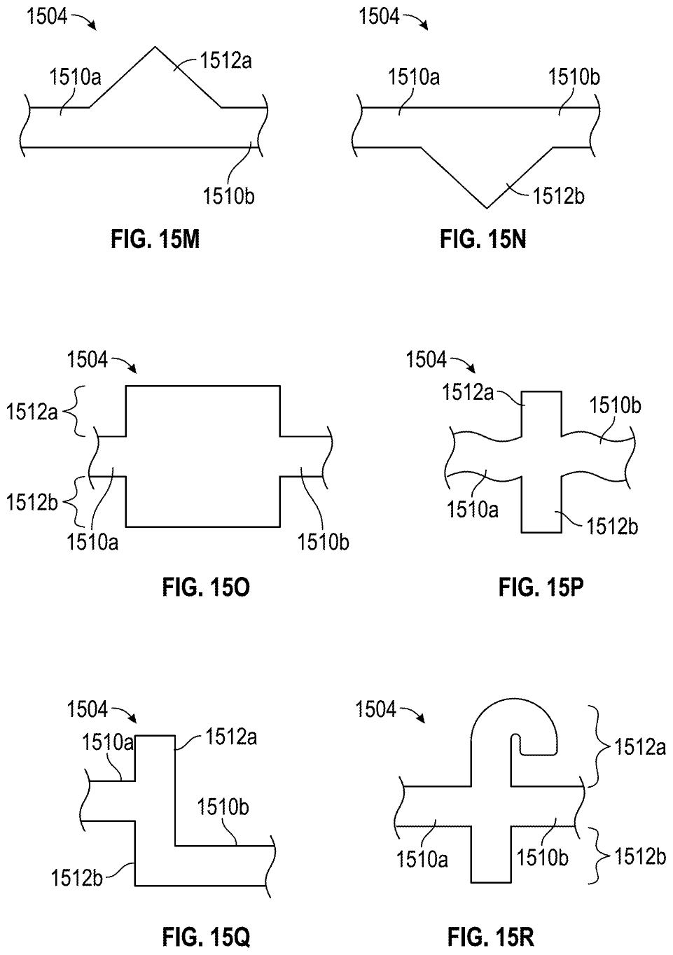

One, some, or all of the attachment portions 1304 may comprise a rigid first portion 1310 that extends along a generally mesiodistal dimension, and a second portion 1312 that is coupled to and extends away from the first portion 1310 along a generally occlusogingival dimension. The first portion 1310 can have a mesial end coupled to a first connector 1302 and a distal end coupled to a second connector 1302. The first portion 1310 may comprise a substantially linear segment of the elongated member 1301 (as shown in FIG. 13B), or may be curved along all or a portion of its length (for example, as shown in FIG. 15P, discussed below). Likewise, the second portion 1312 may comprise a substantially linear segment of the elongated member 1301 (as shown in FIG. 13B), or may be curved along all or a portion of its length (for example, as shown in FIGS. 15F-15L and 15R, discussed below).

The first portion 1310 and the second portion 1312 may be angled relative to one another such that the first and second portions 1310, 1312 together enable the attachment portion 1304 to interlock with a securing member (e.g., a bracket, a composite material, etc.) in such a way that substantially inhibits not only occlusogingival movement of the attachment portion 1304 relative to the tooth to which it is attached, but also substantially inhibits mesiodistal movement of the attachment portion 1304 relative to the tooth to which it is attached. The inclusion of the occlusogingivally-oriented second portion 1312 enables the appliance 1300 to apply a force to a tooth in a mesial or distal direction, which is a significant advantage over orthodontic appliances that do not include a second portion (such as, for example, a bent wire). The second portion 1312 may be substantially perpendicular to the first portion 1310 (as shown in FIG. 13B), or may be positioned at a non-90 degree angle relative to the first portion 1310.

As shown in FIG. 13B, in some embodiments the first portion 1310 may have a mesial region 1310a that extends mesially away from the second portion 1312 and a distal region 1310b that extends distally away from the second portion 1312. Likewise, the second portion 1312 can have one or both of an occlusal region 1312a that extends occlusally away from the first portion 1310 and a gingival region 1312b that extends gingivally away from the first portion 1310. In those embodiments in which the second portion 1312 includes both occlusal and gingival regions 1312a, 1312b, the regions 1312a, 1312b may be generally aligned along a mesiodistal dimension so as to form a ‘+’ shape (as shown in FIG. 13B). In other such embodiments, the occlusal and gingival regions 1312a, 1312b may be offset from one another along the length of the first portion 1310. In some embodiments, the second portion 1312 includes only a gingival region 1312b or only an occlusal region 1312a. Additionally or alternatively, the attachment portion 1304 can include more than one second portion 1312 extending in the same direction. Moreover, while a cross shape is shown in FIGS. 13A and 13B, the first and second portions 1310, 1312 together or individually may form any suitable shape.

As previously mentioned, the attachment portions 1304 may be secured to the teeth via one or more securing members, including any of the composite materials and/or brackets disclosed herein. According to several embodiments, the attachment portions 1304 may be placed against the teeth in a desired position and bonded in place. In some embodiments, the attachment portions 1304 are coupled to the teeth via composite securing members 1303 that include a groove configured to receive an attachment portion 1304 having a complementary shape. The composite material, for example, can comprise any of the composite materials disclosed herein. Once the attachment portion 1304 is positioned within the groove, additional composite may be applied over the attachment portion 1304 to secure the attachment portion 1304 in place.

Referring still to FIG. 13B, adjacent attachment portions 1304 can be coupled to one another via connectors 1302 extending between adjacent attachment portions 1304. One, some, or all of the individual connectors 1302 may be generally aligned with an interdental region (i.e., where adjacent teeth meet) when the appliance 1300 is installed in the patient's mouth. The connectors 1302 may comprise a portion of the elongated member 1301 that is bent out of alignment with the attachment portions 1304. For example, the connectors 1302 may comprise first and second occlusogingival portions 1308 and a mesiodistal portion 1306 disposed at or below the patient's gum line when the appliance 1300 is installed. Each of the first and second occlusogingival portions 1308 can have occlusal ends coupled to an end of an adjacent attachment portion 1304 and gingival ends coupled to the mesiodistal portion 1306.

According to some embodiments, for example as shown in FIG. 13B, each of the first and second occlusogingival portions 1308 and the mesiodistal portion 1306 can be substantially linear. In several embodiments, one, some, or all of the first and second occlusogingival portions 1308 and the mesiodistal portion 1306 can be rigid. For example, as shown in FIG. 13B, the first and second occlusogingival portions 1308 and the mesiodistal portion 1306 are substantially linear and rigid.

In some embodiments, all or a portion of one, some, or all of the first and second occlusogingival portions 1308 and the mesiodistal portion 1306 can be curved. For example, in some embodiments the first and second occlusogingival portions 1308 and the mesiodistal portion 1306 together form a U-shaped portion. In any case, positioning the bent connectors 1308 between the teeth such that the connectors 1308 dip towards the gingiva provides the advantage of allowing the patients to floss. The bent connectors are also relatively compliant so that forces can be applied to adjacent teeth. Other configurations are possible. Different connectors 1302 of the same appliance 1300 can have the same or different shape, size, and/or stiffness.

In some embodiments, all or a portion of one, some, or all of the connectors 1302 and/or all or a portion of the attachment portion 1304 of the appliance 1300 are substantially rigid, thereby preventing any distal or mesial movement between adjacent teeth. Such a configuration may be desired, for example, when the appliance 1300 is installed as a retainer to hold the teeth in place after treatment. In some embodiments, all or a portion of one, some, or all of the connectors 1302 of the appliance 1300 are flexible. For example, one, some, or all of the connectors 1302 may include a biasing portion as disclosed herein. In such embodiments, the connectors 1302 may actively apply forces on the securing members (such as the composite) to move the teeth.

In some embodiments, the connectors 1302 and the attachment portions 1304 are formed of a monolithic structure such that the connectors 1302 and the attachment portions 1304 are integral with one another. For example, as detailed herein, the appliance 1300 can be formed by cutting a desired shape out of a sheet of material and bending and/or otherwise manipulating the shape to conform to a patient's dentition. Additionally or alternatively, the appliance 1300 can be formed by other methods, such as molding, casting, machining, 3D printing, stamping, extruding, or the like.

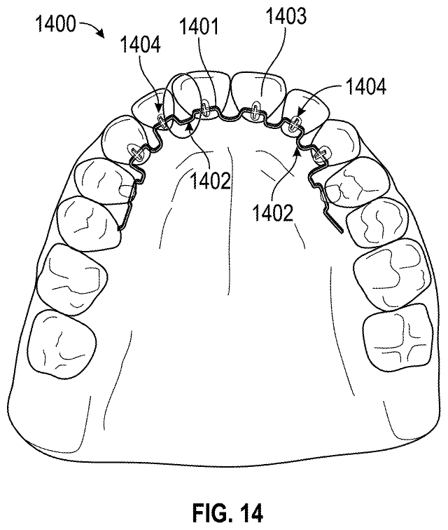

FIG. 14 shows an orthodontic appliance 1400, such as a temporary appliance or permanent retainer, configured to close a space between at least two of the teeth (shown at the circled portion). The appliance 1400 can be substantially the same as appliance 1300, except the mesiodistal portion 1406 of appliance 1400 is substantially linear. As such, the connectors 1402 of appliance 1400 are less flexible than the connectors 1302 of appliance 1300.

FIGS. 15A-15R show examples of different attachment portions 1504 configured in accordance with embodiments of the present technology. The attachment portions 1504 can be used with any of the appliances disclosed herein, including appliance 1100, 1300, 1400, 1600, 2100, 2200, 2300, 2400. FIG. 15A shows an attachment portion 1504 having a single second portion 1512a extending occlusally from the first portion 1510a/1510b. FIG. 15B shows an attachment portion 1504 having a single second portion 1512b extending gingivally from the first portion 1510a/1510b. FIG. 15C shows an attachment portion 1504 having an occlusally-extending second portion 1512a and a gingivally-extending second portion 1512b that are offset along the first portion 1510. As such, a third portion 1510c of the first portion 1510 is positioned between the two second portions 1512a and 1512b.

FIG. 15D shows an attachment portion having second portions 1512a, 1512b that comprise both mesiodistal and occlusogingival segments. In some embodiments, only one of the second portions 1512a, 1512b may comprise both mesiodistal and occlusogingival segments. FIG. 15E also shows an attachment portion 1504 having second portions 1512a, 1512b that comprise both mesiodistal and occlusogingival segments. In contrast to FIG. 15D, the attachment portions 1504 in FIG. 15E are curved. Similar to FIG. 15D, in some embodiments of FIG. 15E, only one of the second portions 1512a, 1512b may comprise both mesiodistal and occlusogingival segments.

The attachment portions 1504 of each of FIGS. 15F, 15G, 15H, and 15I include openings 1514. In FIG. 15F, the opening 1514 is substantially square-shaped, and in FIG. 15G, the opening 1514 is substantially oval-shaped. As discussed herein, other shapes are possible (e.g., rectangular, triangular, polygonal, random, etc.). In FIGS. 15F and 15H, the second portions 1512a, 1512b enclose the opening 1514 at both the occlusal and gingival side of the first portion 1510a/1510b. Likewise, the opening 1514 is disposed at both the occlusal and gingival side of the first portion 1510a/1510b. The second portions 1512a, 1512b can be substantially linear (as in FIG. 15F), curved (as in FIGS. 15G, 15H, and 15I) or both. The attachment portions 1504 of FIGS. 15G and 15I only have one of an occlusally-positioned second portion 1512a or a gingivally-positioned second portion 1512b.

FIG. 15J shows an attachment portion 1504 having an occlusally-positioned second portion 1512a with a rounded occlusal edge. FIG. 15K shows an attachment portion 1504 having a rounded occlusally-positioned second portion 1512a and a rounded gingivally-positioned second portion 1512b. FIG. 15L shows an attachment portion 1504 having asymmetric second portions 1512, 1512b. FIGS. 15M and 15N show attachment portions 1504 having triangular second portions 1512a, 1512b. In FIG. 15M, the attachment portion 1504 includes only an occlusally-positioned second portion 1512a, and in FIG. 15N, the attachment portion 1504 includes only a gingivally-positioned second portion 1512b. In some embodiments, the attachment portion 1504 can include both second portions 1512a, 1512b, one or both of which could be triangular.

FIG. 15O shows an attachment portion 1504 having second portions 1512a, 1512b that together form a solid square. Other shapes are also possible, including any of those disclosed herein. FIG. 15P shows an attachment portion 1504 having a first portion 1510 with curved portions 1510a, 1510b on either side of the second portion 1512a/1512b. FIG. 15Q shows an attachment portion 1504 having first portions 1510a, 1510b that are offset along an occlusogingival dimension and/or along the second portion 1512a/1512b. FIG. 15R shows an attachment portion 1504 having a curved or hook-shaped occlusally-positioned second portion 1512a and a substantially linear gingivally-positioned second portion 1512b.

Any of the shapes or features of any of the attachment portions 1504 can be mixed and matched. For example, the solid attachment portion 1504 shown in FIG. 15O can have any of the openings shown and/or discussed with respect to FIGS. 15F and 15I. Moreover, any of the attachment portions 1504 can be used with the stem portions discussed herein.

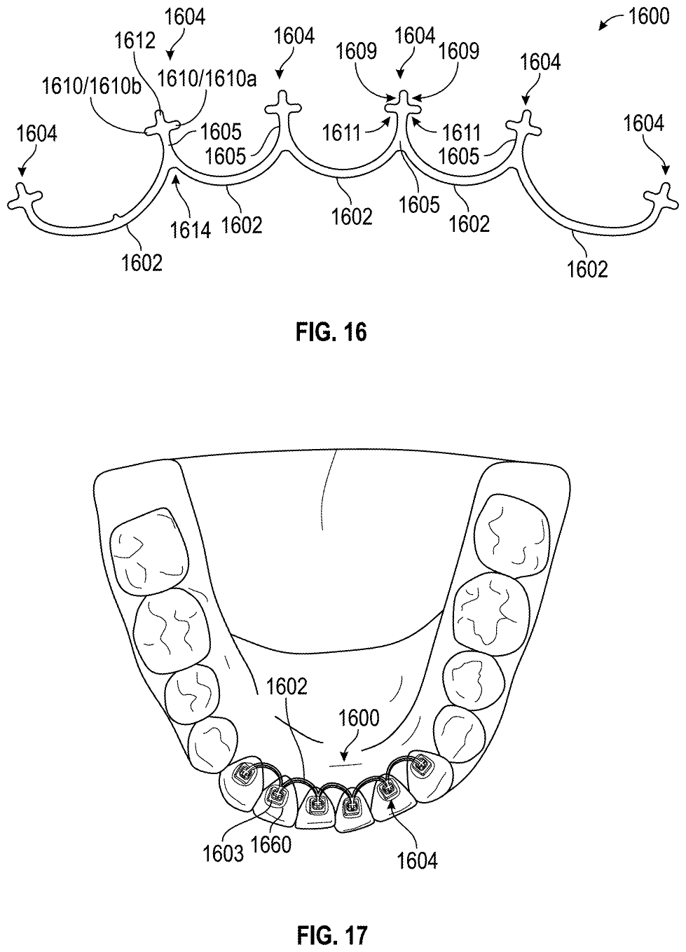

FIG. 16 illustrates an orthodontic appliance 1600 (“appliance 1600”) configured in accordance with several embodiments of the present technology, and FIG. 17 shows the appliance 1600 installed in a patient's mouth adjacent the patient's dentition. Referring to FIGS. 16 and 17 together, the appliance 1600 is configured to be secured to a lingual or buccal surface of the patient's teeth via one or more securing members. The securing members can be brackets, composite material, or both. For example, in FIG. 17, the appliance 1600 is coupled to the teeth via brackets 1660 (only one labeled) and composite material (only one labeled). Similar to appliances 1100 and 1300, the appliance 1600 may be configured to engage a corresponding securing member (e.g., a composite material or a bracket) in such a way that resists or inhibits mesiodistal movement of the appliance 1600 relative to the patient's dentition, thereby enabling the appliance 1600 to apply a force to the tooth to resist or encourage movement.

The appliance 1600 may be configured to be installed as a permanent retainer at the completion of a treatment (i.e., when the teeth are in the FTA) to generally maintain the position of the teeth in the FTA, or may be configured for installation at the beginning or during treatment to reposition one or more of the patient's teeth, or may be configured to both reposition the patient's teeth and retain the patient's teeth in a desired position.

The appliance 1600 may comprise a plurality of connectors 1602 and attachment portions 1604 along its longitudinal axis. The attachment portions 1604 can be configured to be secured to a buccal or lingual surface of a tooth via a securing member, such as a bracket or composite material. The individual connectors 1602 can extend between adjacent attachment portions 1604 and/or any portion of the appliance extending directly from an attachment portion 1604. Adjacent connectors 1602 can attach to one another and/or to an attachment portion 1604 at a junction 1614.

One, some, or all of the attachment portions 1604 can include a first portion 1610 that extends along a generally mesiodistal dimension and a second portion 1612 that extends away from the first portion 1610 along a generally occlusogingival dimension. In some embodiments, one, some, or all of the second portions 1612 extend occlusally away from the first portion 1610. The first portion 1610 can comprise a first arm 1610a extending away from the attachment portion 1604 and/or second portion 1612 in a generally mesial direction and a second arm 1610b extending away from the attachment portion 1604 and/or second portion 1612 in a generally distal direction, or vice versa. In some embodiments the first portion 1610 comprises only the first arm or the second arm. The first portion 1610 and any arms thereof may be substantially linear (as shown in FIG. 16) or may be curved. Likewise, the second portion 1612 may be substantially linear (as shown in FIG. 16) or may be curved.

The appliance 1600 may include a stem portion 1605 extending between an individual junction 1614 and the corresponding attachment portion 1604. In some embodiments, for example as shown in FIG. 16, the stem portion 1605 and the second portion 1612 are generally aligned along a mesiodistal dimension so as to form a ‘+’ or cross shape together with the first and second arms 1610a, 1610b. In other such embodiments, the stem portion 1605 and second portion 1612 can be offset from one another along the length of the first portion 1610 and/or a generally mesiodistal dimension. Additionally or alternatively, the attachment portion 1604 can include more than one second portion 1612 extending in the same direction. Moreover, while a cross shape is shown in FIGS. 16 and 17, the first and second portions 1610, 1612 and/or the stem portion 1605 together or individually may form any suitable shape. In some embodiments, for example, the attachment portions 1604 do not include a second portion 1612 and the first and second arms 1610a, 1610b extend diagonally away from the stem portion 1605 such that that attachment portion 1604 is in the shape of a ‘Y’.

When the appliance 1600 is installed in the patient's mouth, at least a portion of the individual connectors 1602 may span an interdental region, which may be above or below the gums. In FIG. 17, for example, at least a portion of each connector 1602 extends along the gums between the teeth. The connectors 1602 may have a first end at one of the attachment portions 1604, stem portions 1605, and/or junctions 1614, then curve gingivally, then curve back occlusally to an adjacent one of the attachment portions 1604, stem portions 1605, and/or junctions 1614.

Different portions of the attachment portion 1604 and/or adjacent regions of the appliance 1600 may be angled relative to one another such that the angled portions together enable the attachment portion 1604 to interlock with a securing member (e.g., a bracket, a composite material, etc.) in such a way that substantially inhibits not only occlusogingival movement of the attachment portion 1604 relative to the tooth to which it is attached, but also substantially inhibits mesiodistal movement of the attachment portion 1604 relative to the tooth to which it is attached. For example, the first portion 1610 and the second portion 1612 are angled relative to one another to form shoulders 1609, and the first portion 1610 and the stem portion 1605 are angled relative to one another to form shoulders 1611. The inclusion of the occlusogingivally-oriented second portion 1612 and/or stem portion 1605 enables the appliance 1600 to apply a force to a tooth in a mesial or distal direction, which is a significant advantage over orthodontic appliances that do not include a second portion (such as, for example, a bent wire). The second portion 1612 and/or stem portion 1605 may be substantially perpendicular to the first portion 1610 (as shown in FIG. 16), or may be positioned at a non-90 degree angle relative to the first portion 1610.

In some embodiments, all or a portion of one, some, or all of the connectors 1602 and/or all or a portion of the attachment portion 1604 of the appliance 1600 are substantially rigid, thereby preventing any distal or mesial movement between adjacent teeth. Such a configuration may be desired, for example, when the appliance 1600 is installed as a retainer to hold the teeth in place after treatment. In some embodiments, all or a portion of one, some, or all of the connectors 1602 of the appliance 1600 are flexible. For example, one, some, or all of the connectors 1602 may include a biasing portion as disclosed herein. In such embodiments, the connectors 1602 may actively apply forces on the securing members (e.g., brackets, composite material, etc.) to move the teeth.

As previously mentioned, the attachment portions 1604 may be secured to the teeth via one or more securing means, including any of the securing members disclosed herein. As shown in FIG. 17, in some embodiments brackets 1660 may be placed against the teeth in a desired position and bonded to the surface of the tooth. The attachment portion 1604 can then be positioned on the bracket 1660, and a composite material may be applied over the attachment portion 1604 to secure the attachment portion 1604 in place. In some embodiments, the attachment portions 1604 can be bonded to the teeth with composite material and without including a bracket.

In some embodiments, the connectors 1602 and the attachment portions 1604 are formed of a monolithic structure such that the connectors 1602 and the attachment portions 1604 are integral with one another. For example, as detailed herein, the appliance 1600 can be formed by cutting a desired shape out of a sheet of material and bending and/or otherwise manipulating the shape to conform to a patient's dentition. Additionally or alternatively, the appliance 1600 can be formed by other methods, such as molding, casting, machining, 3D printing, stamping, extruding, or the like.

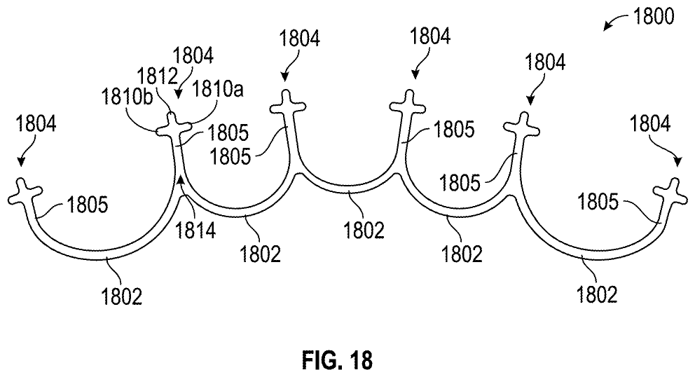

FIG. 18 shows a plan view of an appliance 1800 configured in accordance with embodiments of the present technology. Appliance 1800 can be generally similar to appliance 1600 except as detailed herein. For example, appliance 1800 can have attachment portions 1804 similar to attachment portions 1604, connectors 1604 similar to connectors 1602, stem portions 1805 similar to stem portions 1605, junctions 1814 similar to junctions 1614, etc. In contrast to appliance 1600, however, the stem portions 1805 of appliance 1800 are longer and extend farther from the junction 1814. Such a configuration can be beneficial as it positions the connectors 1802 at a more gingival elevation (as compared to appliance 1600) and guides the connectors 1802 mesiodistally at a level that is below (or gingival of) the gingival line. As such, the connectors 1802 can accommodate teeth having a greater height or a greater distance between the exposed portion of the teeth and the gum line and do not inhibit the patient from flossing between the teeth.

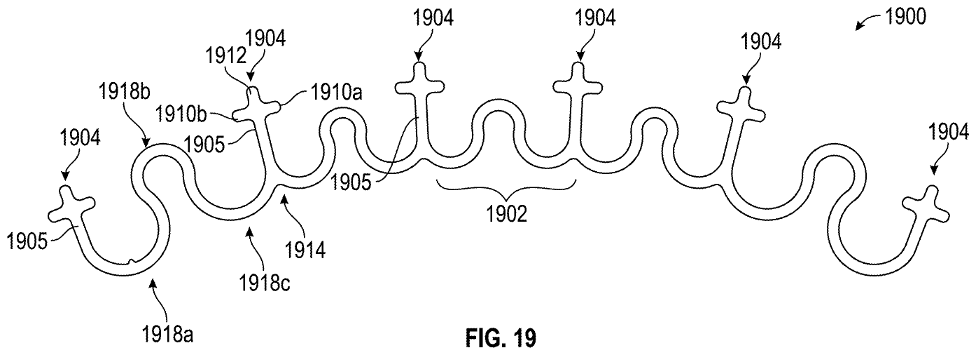

FIG. 19 shows a plan view of an appliance 1900 configured in accordance with embodiments of the present technology. Appliance 1900 can be generally similar to appliance 1600 and appliance 1800, except as detailed herein. For example, appliance 1900 can have attachment portions 1904 similar to attachment portions 1604 and 1804, stems 1905 similar to stem portions 1605 and 1805, junctions 1914 similar to junctions 1614 and 1814, etc. In contrast to appliances 1600 and 1800, however, the individual connectors 1902 of appliance 1900 include multiple peaks and valleys 1918a, 1918b, and 1918c (only one connector 1902 labeled in FIG. 19) between adjacent attachment portions 1904. For example, one, some, or all of the connectors 1902 can extend gingivally away from their corresponding junction or stem portion to a first valley 1918a, then occlusally toward a peak 1918b, then gingivally toward a second valley 1918c, then occlusally to the next junction 1914. One, some, or all of the connectors 1902 may be curved at and between each inflection point. In some embodiments, the connector is substantially linear along all or a portion of its length. Appliance 1900 further differs from appliances 1600 and 1800 in that the individual connectors 1902 extend occlusally to an elevation (along an occlusogingival dimension) that is are at least as occlusal as the adjacent stems 1905, and in some cases as or more occlusal than the adjacent attachment portions 1904. The connectors 1902 of appliance 1900 can be beneficial when greater movement between adjacent teeth is desired as the additional length and curvature provided by the sinuous connectors 1902 affects the biasing force applied by the connector 1902.

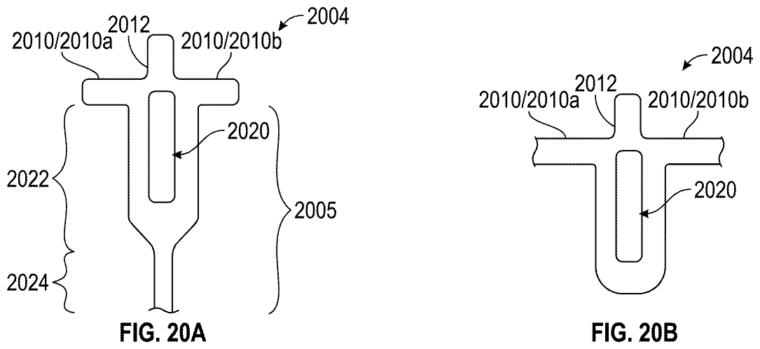

According to several embodiments of the present technology, the stem and/or attachment portion of the appliance may define an opening therethrough. FIGS. 20A and 20B, for example, show a portion of an appliance including an attachment portion 2004 having an opening 2020. The attachment portion 2004 in FIG. 20A is shown as incorporated into an appliance in which at least some of the attachment portions are coupled via occlusogingival connectors. In such embodiments, the gingival end portion of the attachment portion 2004 can be coupled to and/or continuous with a stem, a junction, or directly with one or more connectors. The attachment portion 2004 in FIG. 20B is shown as incorporated into an appliance in which at least some of the attachment portions are coupled via mesiodistal connectors. In such embodiments, the gingival end portion of the attachment portion 2004 does not directly connect to any other portion of the appliance 2000.

As shown, the attachment portion 2004 can have a first portion 2010 that extends along a generally mesiodistal dimension and a second portion 2012 that extends away from the first portion 2010 along a generally occlusogingival dimension. In some embodiments, the second portion 2012 extends occlusally away from the first portion 2010. The first portion 2010 can comprise a first arm 2010a extending away from the attachment portion 2004 and/or second portion 2012 in a generally mesial direction and a second arm 2010b extending away from the attachment portion 2004 and/or second portion 2012 in a generally distal direction, or vice versa. In some embodiments the first portion 2010 comprises only the first arm or the second arm. The first portion 2010 and any arms thereof may be substantially linear (as shown in FIG. 20) or may be curved. Likewise, the second portion 2012 may be substantially linear (as shown in FIG. 20) or may be curved.

The appliance 2000 may include a stem portion 2005 extending between the attachment portion 2004 and a corresponding connector(s) (not shown) and/or junction (not shown). The stem portion 2005 can have a first region 2022 and a second region 2024 along its length. The second region 2024 can extend between the connector(s) and/or junction and the first region 2022 and the first region 2022 can extend between the second region 2024 and the first portion 2010 and/or second portion 2021. The first region 2022 can have a width greater than a width of the second region 2024 to accommodate the opening 2020, as detailed below.

In some embodiments, for example as shown in FIGS. 20A and 20B, the stem portion 2005 and the second portion 2012 are generally aligned along a mesiodistal dimension so as to form a ‘+’ or cross shape together with the first and second arms 2010a, 2010b. In other such embodiments, the stem portion 2005 and second portion 2012 can be offset from one another along the length of the first portion 2010 and/or a generally mesiodistal dimension. Additionally or alternatively, the attachment portion 2004 can include more than one second portion 2012 extending in the same direction. Moreover, while a cross shape is shown in FIG. 20, the first and second portions 2010, 2012 and/or the stem portion 2005 together or individually may form any suitable shape. In some embodiments, for example, the attachment portion 2004 does not include a second portion 2012 and the first and second arms 2010a, 2010b extend diagonally away from the stem portion 2005 such that that attachment portion 2004 is in the shape of a ‘Y’.

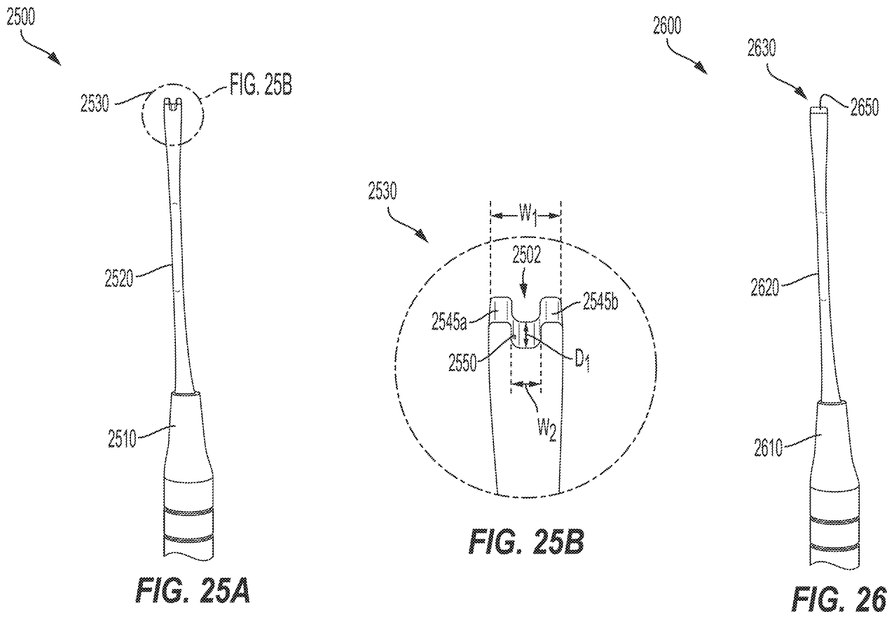

As previously mentioned, the attachment portion 2004 may include an opening 2020 extending through a thickness of the appliance. The opening 2020 can be configured to receive a portion (such as an end portion) of an orthodontic tool to aid an operator in positioning the attachment portion relative to a patient's teeth. Examples of such tools are shown and described with respect to FIGS. 25A, 25B, and 26 herein. In some embodiments the opening 2020 is an elongated, rectangular opening 2020 that extends proximally from the attachment portion 2004 into the stem portion 2005. An occlusal end portion of the opening 2020 can be positioned between the first and second arms 2010a, 2010b, or may be disposed elsewhere. In some embodiments, when the appliance 2000 is installed within a patient's mouth, the opening 2020 generally extends in the occlusogingival direction. In some embodiments, the opening 2020 may be configured such that, when the appliance is installed, the opening 2020 has other orientations.

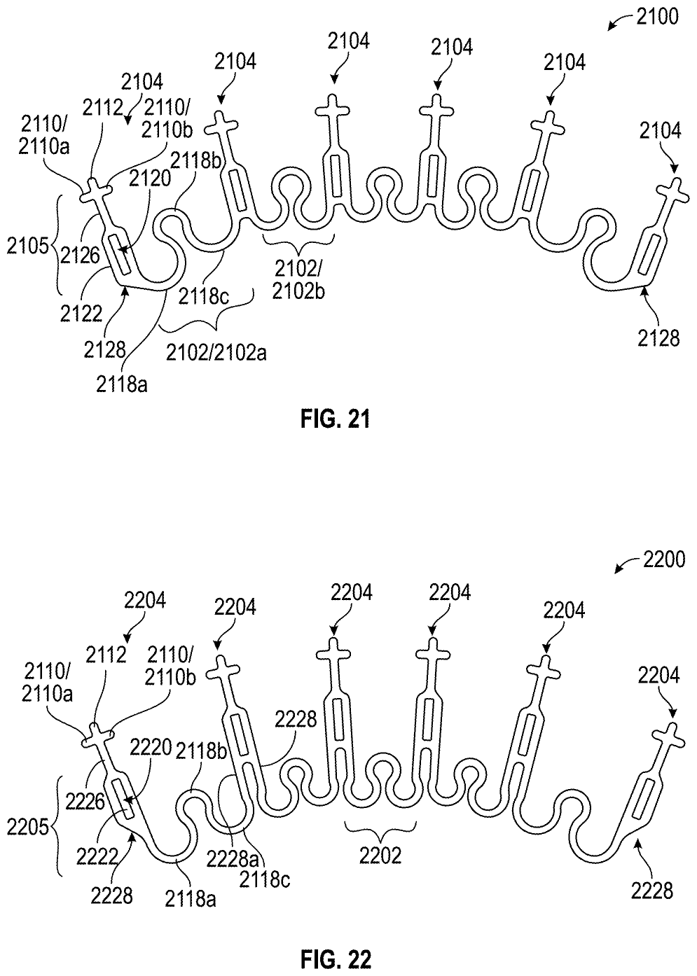

FIG. 21 is a plan view of an appliance 2100 including a plurality of openings 2120 configured in accordance with the present technology. The appliance 2100 may be configured to be secured to a lingual or buccal surface of the patient's teeth via one or more securing members. The securing members can be brackets, composite material, or both. Similar to several other appliances discussed herein, the appliance 2100 may be configured to engage a corresponding securing member (e.g., a composite material or a bracket) in such a way that resists or inhibits mesiodistal movement of the appliance 2100 relative to the patient's dentition, thereby enabling the appliance 2100 to apply a force to the tooth to resist or encourage movement.

The appliance 2100 may be configured to be installed as a permanent retainer at the completion of a treatment (i.e., when the teeth are in the FTA) to generally maintain the position of the teeth in the FTA, or may be configured for installation at the beginning or during treatment to reposition one or more of the patient's teeth, or may be configured to both reposition the patient's teeth and retain the patient's teeth in a desired position.

The appliance 2100 may comprise a plurality of connectors 2102 (only a few labeled), attachment portions 2104, and stem portions 2105 (only one labeled) extending between the individual attachment portion 2104 and one or more connectors 2102. The attachment portions 2104 can be configured to be secured to a buccal or lingual surface of a tooth via a securing member, such as a bracket or composite material. The individual connectors 2102 can extend between adjacent stem portions 2105. A stem portion 2105 can be coupled to a single connector 2102 (for example, at the ends of the appliance 2100) or multiple connectors 2102. The stem portion 2105 can have a first region 2122 and a second region 2126 along its length. The first region 2122 can extend between the connector(s) 2102 and the second region 2126, and the second region 2126 can extend between the first region 2122 and the attachment portion 2104. The first region 2122 can have a width greater than a width of the second region 2126 to accommodate the opening 2120. In some embodiments, the stem portions 2105 do not include the second regions 2126 such that the individual first regions 2122 are substantially continuous with the attachment portion 2104 (for example as shown in FIG. 20).

One, some, or all of the attachment portions 2104 can include a first portion 2110 that extends along a generally mesiodistal dimension and a second portion 2112 that extends away from the first portion 2110 along a generally occlusogingival dimension. In some embodiments, one, some, or all of the second portions 2112 extend occlusally away from the first portion 2110. The first portion 2110 can comprise a first arm 2110a extending away from the attachment portion 2104 and/or second portion 2112 in a generally mesial direction and a second arm 2110b extending away from the attachment portion 2104 and/or second portion 2112 in a generally distal direction, or vice versa. In some embodiments the first portion 2110 comprises only the first arm or the second arm. The first portion 2110 and any arms thereof may be substantially linear (as shown in FIG. 21) or may be curved. Likewise, the second portion 2112 may be substantially linear (as shown in FIG. 21) or may be curved.

In some embodiments, for example as shown in FIG. 21, the second region 2126 of the stem portion 2105 and the second portion 2112 are generally aligned along a mesiodistal dimension so as to form a ‘+’ or cross shape together with the first and second arms 2110a, 2110b. In other such embodiments, the stem portion 2105 and second portion 2112 can be offset from one another along the length of the first portion 2110 and/or a generally mesiodistal dimension. Additionally or alternatively, the attachment portion 2104 can include more than one second portion 2112 extending in the same direction. Moreover, while a cross shape is shown in FIG. 21, the first and second portions 2110, 2112 and/or the stem portion 2105 together or individually may form any suitable shape. In some embodiments, for example, the attachment portions 2104 do not include a second portion 2112 and the first and second arms 2110a, 2110b extend diagonally away from the stem portion 2105 such that that attachment portion 2104 is in the shape of a ‘Y’.

When the appliance 2100 is installed in the patient's mouth, at least a portion of the individual connectors 2102 may span an interdental region, which may be above or below the gums. As shown in FIG. 21, the individual connectors 2102 can include multiple peaks and valleys 2118a, 2118b, and 2118c (only one connector 2102 labeled in FIG. 21) between adjacent attachment portions 2104. For example, one, some, or all of the connectors 2102 can extend gingivally away from a corresponding stem portion 2105 to a first valley 2118a, then occlusally toward a peak 2118b, then gingivally toward a second valley 2118c, then occlusally to the next stem portion 2105. One, some, or all of the connectors 2102 may be curved at and between each inflection point. In some embodiments, one, some, or all of the connectors 2102 are substantially linear along all or a portion of its length.

In some embodiments, the connectors 2102 may be connected to a gingival end portion of the first region 2122 of the stem portion 2105. For example, as shown in FIG. 21, at least some of the gingival end portions of the first regions 2122 can connect directly to an end of a first connector 2102a and an end of a second connector 2102b. In some embodiments, an outer side 2128 of the gingival end portions of the first regions 2122 can be slanted.

In contrast to appliance 1900, the individual connectors 2102 of appliance 2100 extend occlusally to an elevation (along an occlusogingival dimension) that is gingival of the attachment portions 2104. In many cases, such a configuration ensures that all or a majority of the connectors 2102 are positioned across the interdental region below the gum line, thereby allowing a patient to floss with greater ease.

Different portions of the attachment portion 2104 and/or adjacent regions of the appliance 2100 may be angled relative to one another such that the angled portions together enable the attachment portion 2104 to interlock with a securing member (e.g., a bracket, a composite material, etc.) in such a way that substantially inhibits not only occlusogingival movement of the attachment portion 2104 relative to the tooth to which it is attached, but also substantially inhibits mesiodistal movement of the attachment portion 2104 relative to the tooth to which it is attached. For example, the first portion 2110 and the second portion 2112 are angled relative to one another to form shoulders 2109, and the first portion 2110 and the stem portion 2105 are angled relative to one another to form shoulders 2111. The inclusion of the occlusogingivally-oriented second portion 2112 and/or stem portion 2105 enables the appliance 2100 to apply a force to a tooth in a mesial or distal direction, which is a significant advantage over orthodontic appliances that do not include a second portion (such as, for example, a bent wire). The second portion 2112 and/or stem portion 2105 may be substantially perpendicular to the first portion 2110 (as shown in FIG. 21), or may be positioned at a non-90 degree angle relative to the first portion 2110.

In some embodiments, all or a portion of one, some, or all of the connectors 2102 and/or all or a portion of the attachment portion 2104 of the appliance 2100 are substantially rigid, thereby preventing any distal or mesial movement between adjacent teeth. Such a configuration may be desired, for example, when the appliance 2100 is installed as a retainer to hold the teeth in place after treatment. In some embodiments, all or a portion of one, some, or all of the connectors 2102 of the appliance 2100 are flexible. For example, one, some, or all of the connectors 2102 may include a biasing portion as disclosed herein. In such embodiments, the connectors 2102 may actively apply forces on the securing members (e.g., brackets, composite material, etc.) to move the teeth.

As previously mentioned, the attachment portions 2104 may be secured to the teeth via one or more securing means, including any of the securing members disclosed herein, such as any of securing members 1160, 1260, 1260′, 2760, 2860, 2960, 3060 and 3160. In some embodiments, securing members may be placed against the teeth in a desired position and bonded to the tooth. The attachment portion 2104 can then be positioned on the bracket, and a composite material may be applied over the attachment portion 2104 to secure the attachment portion 2104 in place. In some embodiments, the attachment portions 2104 can be bonded to the teeth with composite material and without including a bracket.

In some embodiments, the connectors 2102 and the attachment portions 2104 are formed of a monolithic structure such that the connectors 2102 and the attachment portions 2104 are integral with one another. For example, as detailed herein, the appliance 2100 can be formed by cutting a desired shape out of a sheet of material and bending and/or otherwise manipulating the shape to conform to a patient's dentition. Additionally or alternatively, the appliance 2100 can be formed by other methods, such as molding, casting, machining, 3D printing, stamping, extruding, or the like.

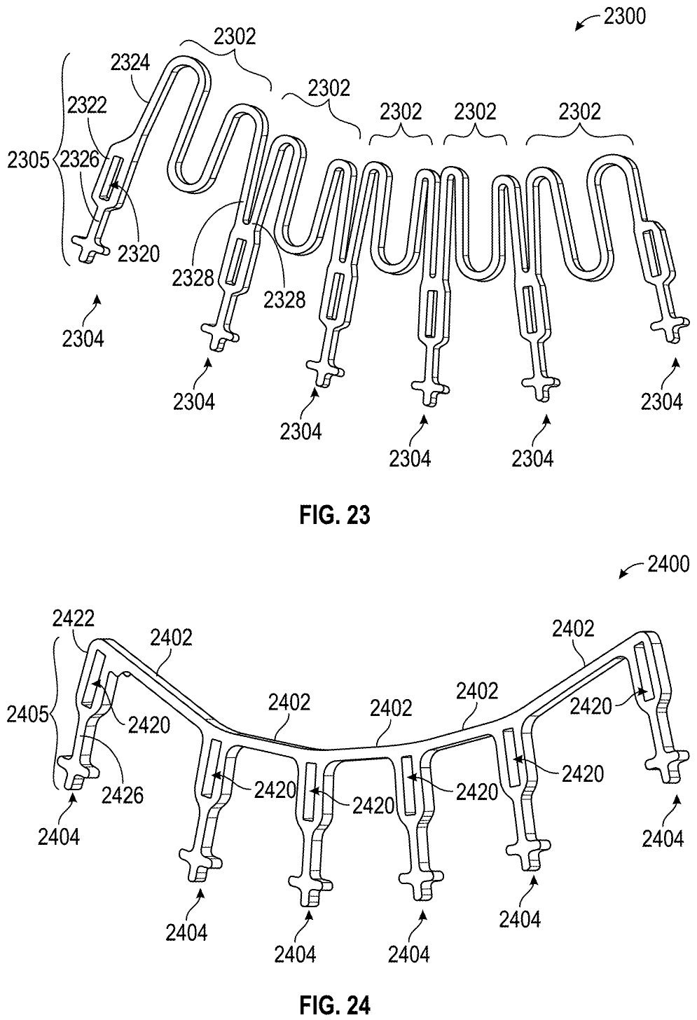

FIG. 22 is a plan view of an appliance 2200 including a plurality of openings 2220 configured in accordance with the present technology. Appliance 2200 can be generally similar to appliance 2100 and can have any of the variations discussed with respect to the appliance 2100, except as detailed herein. For example, appliance 2200 can have attachment portions 2204 similar to attachment portions 2104, connectors 2202 similar to connectors 2102, stem portions 2205 similar to stems portions 2105, etc. In contrast to appliance 2100, however, appliance 2200 has substantially linear extensions 2228 (only two labeled) extending gingivally from the gingival end portion of the stem portion 2205 and/or first region 2222 of the stem portion 2205, effectively increasing a distance between the connectors 2202 (and any peak or valley thereof) and the attachment portions 2204. In FIG. 22, the extensions 2228 extend substantially parallel to one another. In some embodiments, for example as shown in appliance 2300 of FIG. 23, the extensions 2228 can extend at an angle relative to one another such that the gingival ends of the extensions 2228 are spaced farther apart along a mesiodistal dimension than the occlusal ends. FIG. 23 also illustrates another connector variation in which the portions of the connectors 2302 between the peaks and valleys are substantially linear, which is in contrast to the examples depicted in FIGS. 21 and 22 in which the portions of the connectors 2102 and 2202 between the peaks and valleys are curved.

FIG. 24 is an isometric view of an appliance 2400 including a plurality of openings 2420 configured in accordance with the present technology. The appliance 2400 may be configured to be secured to a lingual or buccal surface of the patient's teeth via one or more securing members. The securing members can be brackets, composite material, or both. Similar to several other appliances discussed herein, the appliance 2400 may be configured to engage a corresponding securing member (e.g., a composite material or a bracket) in such a way that resists or inhibits mesiodistal movement of the appliance 2400 relative to the patient's dentition, thereby enabling the appliance 2400 to apply a force to the tooth to resist or encourage movement.

The appliance 2400 may be configured to be installed as a permanent retainer at the completion of a treatment (i.e., when the teeth are in the FTA) to generally maintain the position of the teeth in the FTA, or may be configured for installation at the beginning or during treatment to reposition one or more of the patient's teeth, or may be configured to both reposition the patient's teeth and retain the patient's teeth in a desired position.

The appliance 2400 may comprise a plurality of connectors 2402, attachment portions 2404, and stem portions 2405 (only one labeled) extending between the individual attachment portion 2404 and one or more connectors 2402. The attachment portions 2404 can be configured to be secured to a buccal or lingual surface of a tooth via a securing member, such as a bracket or composite material. The individual connectors 2402 can extend between adjacent stem portions 2405. A stem portion 2405 can be coupled to a single connector 2402 (for example, at the ends of the appliance 2400) or multiple connectors 2402. The stem portion 2405 can have a first region 2422 and a second region 2426 along its length. The first region 2422 can extend between the connector(s) 2402 and the second region 2426, and the second region 2426 can extend between the first region 2422 and the attachment portion 2404. The first region 2422 can have a width greater than a width of the second region 2426 to accommodate the opening 2420. In some embodiments, the stem portions 2405 do not include the second regions 2426 such that the individual first regions 2422 are substantially continuous with the attachment portion 2404 (for example as shown in FIG. 20).

One, some, or all of the attachment portions 2404 can include a first portion 2410 that extends along a generally mesiodistal dimension and a second portion 2412 that extends away from the first portion 2410 along a generally occlusogingival dimension. In some embodiments, one, some, or all of the second portions 2412 extend occlusally away from the first portion 2410. The first portion 2410 can comprise a first arm 2410a extending away from the attachment portion 2404 and/or second portion 2412 in a generally mesial direction and a second arm 2410b extending away from the attachment portion 2404 and/or second portion 2412 in a generally distal direction, or vice versa. In some embodiments the first portion 2410 comprises only the first arm or the second arm. The first portion 2410 and any arms thereof may be substantially linear (as shown in FIG. 24) or may be curved. Likewise, the second portion 2412 may be substantially linear (as shown in FIG. 24) or may be curved.

In some embodiments, for example as shown in FIG. 24, the second region 2426 of the stem portion 2405 and the second portion 2412 are generally aligned along a mesiodistal dimension so as to form a ‘+’ or cross shape together with the first and second arms 2410a, 2410b. In other such embodiments, the stem portion 2405 and second portion 2412 can be offset from one another along the length of the first portion 2410 and/or a generally mesiodistal dimension. Additionally or alternatively, the attachment portion 2404 can include more than one second portion 2412 extending in the same direction. Moreover, while a cross shape is shown in FIG. 24, the first and second portions 2410, 2412 and/or the stem portion 2405 together or individually may form any suitable shape. In some embodiments, for example, the attachment portions 2404 do not include a second portion 2412 and the first and second arms 2410a, 2410b extend diagonally away from the stem portion 2405 such that that attachment portion 2404 is in the shape of a ‘Y’.

When the appliance 2400 is installed in the patient's mouth, at least a portion of the individual connectors 2402 may span an interdental region, which may be above or below the gums. As shown in FIG. 24, the individual connectors 2402 can be substantially linear, thereby providing a more rigid connection between adjacent attachment portions 2404 and/or stem portions 2405 and allowing less movement than a curved connector. Such a configuration may be desired, for example, when the appliance 2400 is installed as a retainer to hold the teeth in place after treatment. In some embodiments, all or a portion of one, some, or all of the connectors 2402 of the appliance 2400 are curved and/or relatively flexible. For example, one, some, or all of the connectors 2402 may include a biasing portion as disclosed herein. In such embodiments, the connectors 2402 may actively apply forces on the securing members (e.g., brackets, composite material, etc.) to move the teeth.

In some embodiments, the connectors 2402 may be connected to a gingival end portion of the first region 2422 of the stem portion 2405. For example, as shown in FIG. 24, at least some of the gingival end portions of the first regions 2422 can connect directly to an end of a first connector 2402a and an end of a second connector 2402b.

Different portions of the attachment portion 2404 and/or adjacent regions of the appliance 2400 may be angled relative to one another such that the angled portions together enable the attachment portion 2404 to interlock with a securing member (e.g., a bracket, a composite material, etc.) in such a way that substantially inhibits not only occlusogingival movement of the attachment portion 2404 relative to the tooth to which it is attached, but also substantially inhibits mesiodistal movement of the attachment portion 2404 relative to the tooth to which it is attached. For example, the first portion 2410 and the second portion 2412 are angled relative to one another to form shoulders 2409, and the first portion 2410 and the stem portion 2405 are angled relative to one another to form shoulders 2411. The inclusion of the occlusogingivally-oriented second portion 2412 and/or stem portion 2405 enables the appliance 2400 to apply a force to a tooth in a mesial or distal direction, which is a significant advantage over orthodontic appliances that do not include a second portion (such as, for example, a bent wire). The second portion 2412 and/or stem portion 2405 may be substantially perpendicular to the first portion 2410 (as shown in FIG. 24), or may be positioned at a non-90 degree angle relative to the first portion 2410.

As previously mentioned, the attachment portions 2404 may be secured to the teeth via one or more securing means, including any of the securing members disclosed herein, such as any of securing members 1160, 1260, 1260′, 2760, 2860, 2960, 3060 and 3160. In some embodiments, securing members may be placed against the teeth in a desired position and bonded in place. The attachment portion 2404 can then be positioned on the bracket, and a composite material may be applied over the attachment portion 2404 to secure the attachment portion 2404 in place. In some embodiments, the attachment portions 2404 can be bonded to the teeth with composite material and without including a bracket.

In some embodiments, the connectors 2402 and the attachment portions 2404 are formed of a monolithic structure such that the connectors 2402 and the attachment portions 2404 are integral with one another. For example, as detailed herein, the appliance 2400 can be formed by cutting a desired shape out of a sheet of material and bending and/or otherwise manipulating the shape to conform to a patient's dentition. Additionally or alternatively, the appliance 2400 can be formed by other methods, such as molding, casting, machining, 3D printing, stamping, extruding, or the like.

FIGS. 25A and 25B show an orthodontic tool 2500 to be used with the orthodontic appliances of the present technology. As shown in FIG. 25A, the tool 2500 includes a handle 2510 and a neck 2520 extending distally from the handle 2510. FIG. 25B shows an enlarged view of a distal end portion 2530 of the tool 2500. In some embodiments, the tool 2500 can include a notch 2502 defined by a recessed end surface 2550 of the tool 2500. The distal end portion 2530 can have a generally rectangular cross-sectional shape with a width W₁ and a depth D₁. In some embodiments, the notch 2502 extends through the entire depth of the distal end portion 2530. For example, as shown in FIG. 25B, the notch 2502 can have a width W₂ bound by sidewalls 2545a, 2545b and the same depth as the distal end portion 2530. In some embodiments, the notch 2502 extends through only a portion of the depth of the distal end portion 2530. In some embodiments, a cross-sectional shape and/or dimension of the distal end portion 2530 can be approximately equal to a cross-sectional shape and/or dimension of any one of the openings 2020, 2420, 2220, 2320, 2420 of corresponding stem portions 2005, 2405, 2205, 2305, 2405. As such, insertion of the end portion 2530 into any one of the openings 2020, 2420, 2220, 2320, 2420 allows an operator to manipulate and position the corresponding stem portion and/or attachment portion more easily. This fine control can be beneficial, for example, when positioning the corresponding attachment portion on a tooth or securing member. It will be appreciated that the distal end portion 2530 can have other cross-sectional shapes, such as that of a square, a circle, an oval, a polygon, a triangle, and/or any suitable shape. The cross-sectional shape of the distal end portion 2530 can match that of any opening within an attachment portion, stem portion, and/or any other portion of an appliance which, as discussed, can be any shape.

FIG. 26 shows another tool 2600 configured in accordance with several embodiments of the present technology. Tool 2600 can be generally similar to tool 2500, except tool 2600 does not include a notch at its distal end surface 2650. Instead, the distal end surface 2650 is substantially flat. The distal end portion 2630 can have a generally rectangular cross-sectional shape with a width W₁ and a depth D₁. In some embodiments, a cross-sectional shape and/or dimension of the distal end portion 2630 can be approximately equal to a cross-sectional shape and/or dimension of any one of the openings 2020, 2420, 2220, 2320, 2420 of corresponding stem portions 2005, 2405, 2205, 2305, 2405. It will be appreciated that the distal end portion 2630 can have other cross-sectional shapes, such as that of a square, a circle, an oval, a polygon, a triangle, and/or any suitable shape. The cross-sectional shape of the distal end portion 2630 can match that of any opening within an attachment portion, stem portion, and/or any other portion of an appliance which, as discussed, can be any shape.

FIGS. 27-30 illustrate different low-profile securing members configured in accordance with several embodiments of the present technology. Such low-profile designs are more comfortable for the patient. As shown in FIG. 27, several embodiments of the present technology include a securing member 2760 configured to be positioned at a buccal or lingual surface of a patient's tooth. The securing member 2760 can be configured to receive an attachment portion thereon and be secured to the attachment portion via the addition of a composite material, as discussed in greater detail below. FIG. 28 shows an attachment portion received by a securing member 2860 similar to securing member 2760, except securing member 2860 does not include any recesses (discussed here).

The securing member 2760 has a first side (not visible) configured to be positioned against and/or adjacent a patient's tooth, a second side 2701 configured to face away from the tooth, and a thickness measured therebetween. The second side 2701 can comprise a substantially flat surface 2702 having a plurality of depressions 2706 (only a few labeled). The depressions 2706 can be evenly or randomly spaced along the surface 2702 and can have any suitable shape (e.g., square, circle, oval, rectangle, polygon, random, etc.). The depressions 2706 increase the surface area at the second side 2701 of the securing member 2760 (as compared to a comparably sized securing member with only a substantially flat surface) which improves the bond strength between the surface 2702 and the later-applied composite material. In addition, the depressions 2706 provide a means for increasing the surface area at the second side 2701 without increasing the overall footprint of the securing member, which is beneficial for patient comfort. Instead of or in addition to the depressions 2706, the surface 2702 can have other surface features that increase the surface area at the second side 2701 without increasing the overall footprint of the securing member 2760. Other surface features can include, for example, one or more bumps.

The second side 2701 of the securing member 2760 can also comprise a plurality of protrusions 2704 extending away from the surface 2702 and spaced apart by gaps 2708. The securing member 2760 shown in FIG. 27 includes four protrusions 2704 arranged in four quadrants such that the gaps define a ‘+’ or cross-shaped recess at the second side 2701. The number, shape, and/or arrangement of the protrusions 2704 can be configured to form a recess having any shape complementary to that of an attachment portion (such as any of the attachment portions disclosed herein) and that provides opposition to both mesiodistal and occlusogingival movement of the attachment portion. In FIG. 27, for example, each of the protrusions 2704 has a first surface 2710 (only two labeled) lying in a generally occlusogingivally-oriented plane and a second surface 2712 (only two labeled) lying in a generally mesiodistally-oriented plane. The first surfaces 2710 are configured to oppose mesiodistal movement and rotation of the secured attachment portion, and the second surfaces 2712 are configured to oppose occlusogingival movement and rotation of the secured attachment portion. According to several embodiments, the first and second surfaces 2710, 2712 of the protrusions 2704 can be substantially flat for opposing movement of the attachment portion, and the lingual (or buccal) surface of the protrusions are generally curved. In some embodiments, the one or both of the first and second surfaces 2710, 2712 are curved and the lingual (or buccal) surfaces of one, some, or all of the protrusions are substantially flat.

Although four protrusions 2704 are shown in FIG. 27, the securing member 2760 can have any number of protrusions, such as one, two, three, four, five, six, etc. Moreover, in FIG. 27, the securing member 2760 only has depressions 2706 at the second side 2701 (and not the first side or the sidewalls). In some embodiments, the securing member 2760 can have depressions 2706 and/or other surface features at one, some, or all of the first side, the second side 2701, and the sidewalls.

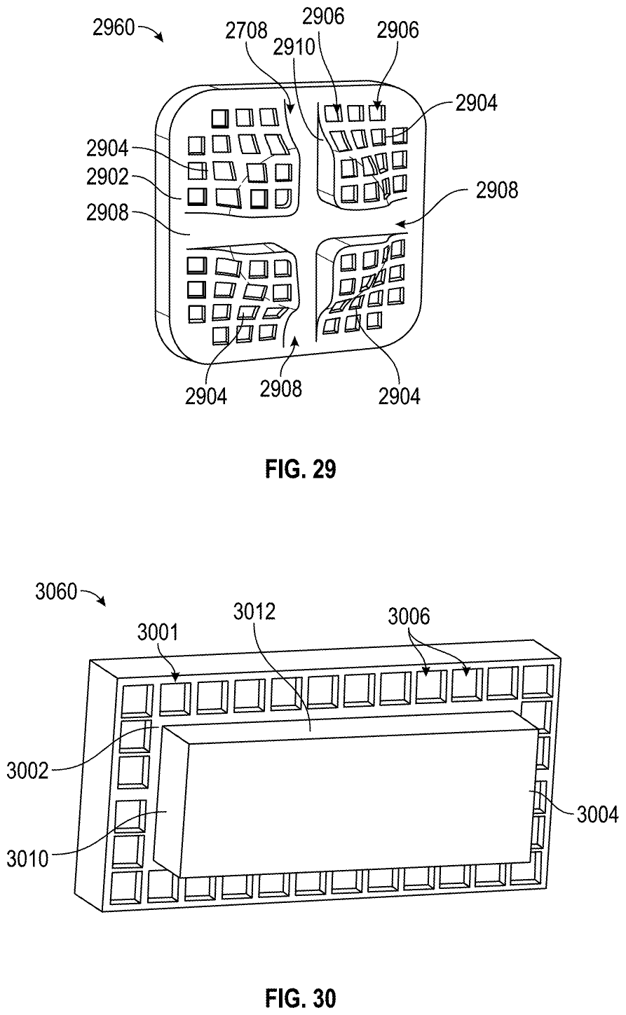

As shown in FIG. 27, in some embodiments the protrusions 2704 do not include any depressions 2706, and instead the depressions 2706 are disposed only along the substantially flat surface 2702 around and between the protrusions 2704, including within the gaps 2708. In some embodiments, the securing member 2760 does not include depressions 2706 at the portion of the surface 2702 between the protrusions 2704 and the edge of the securing member 2760 and/or the portion of the surface 2702 between the protrusions 2704. FIG. 29, for example, shows a securing member 2960 substantially the same as securing member 2760, except securing member 2960 has depressions 2906 only on the protrusions 2704 and not around and between the protrusions 2704 (as in FIG. 27).

FIG. 30 depicts a low-profile bracket 3060 configured in accordance with several embodiments of the present technology. The securing member 3060 is configured to be positioned at a buccal or lingual surface of a patient's tooth. The securing member 3060 can be configured to receive an attachment portion thereon and be secured to the attachment portion via the addition of a composite material, as discussed in greater detail below.

The securing member 3060 has a first side (not visible) configured to be positioned against and/or adjacent a patient's tooth, a second side 3001 configured to face away from the tooth, and a thickness measured therebetween. The second side 3001 can comprise a substantially flat surface 3002 having a plurality of depressions 3006 (only a few labeled). The depressions 3006 can be evenly or randomly spaced along the surface 3002 and can have any suitable shape (e.g., square, circle, oval, rectangle, polygon, random, etc.). The depressions 3006 increase the surface area at the second side 3001 of the securing member 3060 (as compared to a comparably sized securing member with only a substantially flat surface) which improves the bond strength between the surface 3002 and the later-applied composite material. In addition, the depressions 3006 provide a means for increasing the surface area at the second side 3001 without increasing the overall footprint of the securing member, which is beneficial for patient comfort. Instead of or in addition to the depressions 3006, the surface 3002 can have other surface features that increase the surface area at the second side 3001 without increasing the overall footprint of the securing member 3060. Other surface features can include, for example, one or more bumps.

The second side 3001 of the securing member 3060 can comprise a single protrusion 3004 extending away from the surface 3002. In FIG. 30, the protrusion 3004 has a rectangular shape. In some embodiments, the protrusion 3004 has other shapes, such as a square, circle, triangle, polygon, oval, or random shape. In any case, the shape of the protrusion 3004 can be configured to complement that of an opening in an attachment portion. For example, an attachment portion comprising a rectangular opening could be configured to fit around the protrusion 3004. The shape of the protrusion 3004 can also be configured to provide opposition to both mesiodistal and occlusogingival movement of the attachment portion. In FIG. 30, for example, the protrusion 3004 has two first surfaces 3010 (only one labeled) lying in a generally occlusogingivally-oriented plane and two second surfaces 3012 (only one labeled) lying in a generally mesiodistally-oriented plane. The first surfaces 3010 are configured to oppose mesiodistal movement and rotation of the secured attachment portion, and the second surfaces 3012 are configured to oppose occlusogingival movement and rotation of the secured attachment portion.

In FIG. 30, the securing member 3060 only has depressions 3006 at the second side 3001 (and not the first side or the sidewalls). In some embodiments, the securing member 3060 can have depressions 3006 and/or other surface features at one, some, or all of the first side, the second side 3001, and the sidewalls.

Any of the securing members disclosed herein, including any of the hybrid securing members, can be manufactured as a single piece via 3D printing, molding, casting, or the like.

For any of the embodiments disclosed herein, the securing member can comprise a curable material such that the securing member may be bonded directly to a patient's tooth, e.g., without the need for additional materials or bonding agents. The curable material can be the composite material, or may be another material. In some embodiments, the curable material can be generally moldable prior to being cured, and can include a composite resin, ceramic, and/or other synthetic material. In some embodiments, the curable material can include dimethacrylate monomers, a filler material (e.g., silica), and/or a photoinitiator that may be activated by UV light for bonding. Any of the securing members and/or composite materials disclosed herein can comprise a curable material, an adhesive, a composite resin, and/or other synthetic non-rigid materials.

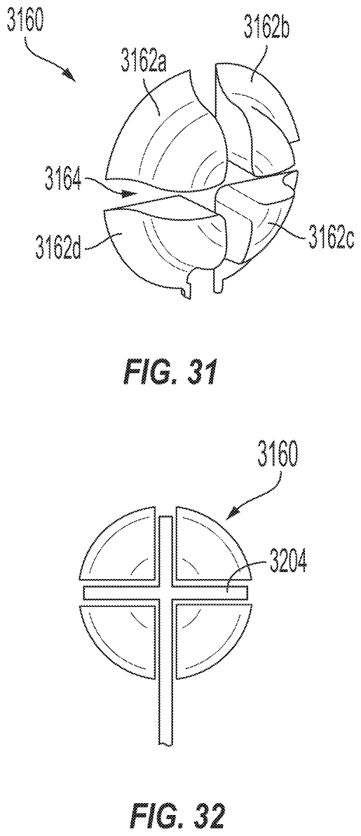

As previously mentioned, the present technology includes securing members made entirely of a curable composite material. FIG. 31, for example, shows a securing member 3160 formed entirely of a curable composite material and configured in accordance with several embodiments of the present technology. The securing member 3160 can include one or more distinct support portions 3162a-d (collectively, “support portions 3162”), each comprising a cured composite material. The support portions 3162a-d may be spaced apart from one another to define a gap 3164. Although the securing member 3160 shown in FIG. 31 has four support portions 3162a-d, in some embodiments, the securing member 3160 may have more or fewer than four portions (e.g., two portions, three portions, five portions, six portions, etc.). As shown in FIG. 31, the gap 3164 may form a generally cross or “+” shape. A shape of the gap 3164 may be based, at least in part, on a shape of the attachment portion configured to be coupled to the securing member 3160. For example, the cross-shaped gap 3164 depicted in FIG. 31 may be configured to receive a cross-shaped attachment portion, such as any of attachment portions 1104, 1204, 1204′, 1304, 1404, 2004, 2104, 2204, 2304, 2404 and 2504. The support portions can have other shapes and/or other arrangements. For example, the support portions can be shaped and/or arranged to form a gap configured to receive non-cross-shaped attachment portions, such as attachment portions 1104, 1204, 1204′, and any of attachment portions 1504.

The securing member 3160 may be configured to be bonded directly to a patient's tooth, e.g., without the need for additional materials (such as a bracket) or bonding agents. The composite material can be generally moldable prior to being cured, and can comprise a composite resin, ceramic, and/or other synthetic material. In some embodiments, the composite material can include dimethacrylate monomers, a filler material (e.g., silica), and/or a photoinitiator that may be activated by UV light for bonding. The composite material can be configured to be bonded directly to the patient's tooth.

FIG. 32 is a front view of an attachment portion 3204 of an orthodontic appliance coupled to the securing member 3160. The attachment portion 3204 can correspond to any one of the attachment portions described herein. As shown in FIG. 32, the attachment portion 3204 may have a shape complementary to a shape of the gap 3164 (FIG. 31) formed by the support portions 3162a-d. The complementary nature of the shape of the attachment portion 3204 to the gap 3164 can help inhibit movement of the attachment portion 3204 relative to the gap 3164 along and/or about the mesial-distal, occlusal-gingival, and/or lingual-facial axes.

According to some embodiments, the securing member 3160 may be manufactured and coupled to a patient's tooth simultaneously. Manufacturing the securing member 3160 can include providing a support (e.g., a tray) having recesses with shapes complementary to the shapes of the support portions 3162a-d shown in FIG. 31. The recesses of the support may be filled with the composite material in a moldable form, and the support may be subsequently positioned on a surface of a patient's tooth in a desired location. Energy (e.g., UV light, thermal energy, etc.) is applied to the support and composite material to form a cured structure. In some embodiments, the applied energy may also cause the composite material to bond to the patient's tooth. In some embodiments, an adhesive that does not require UV light to cure may be used. After curing, the support can be removed from the patient's mouth while the cured material (i.e., the securing member 3160) remains attached to the patient's tooth. An attachment portion of an appliance can then be positioned within the gap 3164 defined by the support portions 3162. The attachment portion can be secured by disposing an adhesive, composite resin, or other synthetic material over the attachment portion within the gap. The adhesive, composite resin, or synthetic material used to secure the attachment portion to the securing member 3160 may be cured via UV light. In some embodiments, the attachment portion is secured to the securing member 3160 without UV light.

In some embodiments, the securing member 3160 is first cured and then coupled to a patient's tooth.

The securing members of the present technology can be attached to the surface of a tooth using any suitable technique or combination of techniques. For example, the securing member can be bonded to the surface of a tooth using a suitable adhesive or cement. The securing member need not be adhesively bonded. Further, any of the securing members may be formed entirely from a curable composite material and cured in vivo on the patient's teeth or prior to bonding to the patient's teeth.

Any of the appliances and/or connectors disclosed herein with respect to FIGS. 11A-24 can have any of the features and/or configurations disclosed with respect to FIGS. 3A-10. For example, any of the appliances and/or connectors disclosed herein with respect to FIGS. 11A to 24 can have any of the arms 130 and/or biasing portions 150 shown in FIGS. 3A-10. As one of many examples, any of the connectors 1102, 1202, 1302, 1402, 1602, 1802, 1902, 2102, 2202, 2302 and 2402 can have a biasing portion 150. The biasing portion 150 can be u-shaped, serpentine, or any of the shapes disclosed herein. Moreover, any of the appliances and/or connectors disclosed herein with respect to FIGS. 11A-24 can have any of the features and/or configurations disclosed with respect to another one of FIGS. 11A-24. As one of many examples, in some embodiments one, some, or all of the connectors 1602 of appliance 1600 is shaped like any of connectors 2102, 2302, or any of the shapes of the connectors and/or biasing portions disclosed herein.

### Conclusion

Although many of the embodiments are described above primarily with respect to systems, devices, and methods for orthodontic appliances positioned on a lingual side of a patient's teeth, the technology is applicable to other applications and/or other approaches, such as orthodontic appliances positioned on a facial side of the patient's teeth. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1-32.

The descriptions of embodiments of the technology are not intended to be exhaustive or to limit the technology to the precise form disclosed above. Where the context permits, singular or plural terms may also include the plural or singular term, respectively. For example, embodiments described herein as using multiple coupling arms may just as well be modified to include fewer (e.g., one) or more (e.g., three) coupling arms. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. A securing member for securing an attachment portion of an orthodontic appliance to a tooth of a patient, the securing member comprising:
a first support configured to extend away from the tooth when the securing member is secured to the tooth, wherein the first support has an occlusally-facing surface configured to abut a gingivally-facing surface of the attachment portion and thereby inhibit gingival movement of the attachment portion; and
a second support configured to extend away from the tooth when the securing member is secured to the tooth, wherein the second support is spaced apart from the first support by a gap when the securing member is secured to the tooth, the gap being configured to receive the attachment portion therein, and wherein the second support has:
a mesially-facing surface configured to abut a distally-facing surface of the attachment portion and thereby inhibit distal movement of the attachment portion,
a distally-facing surface configured to abut a mesially-facing surface of the attachment portion and thereby inhibit mesial movement of the attachment portion, and
a gingivally-facing surface configured to abut an occlusally-facing surface of the attachment portion and thereby inhibit occlusal movement of the attachment portion,
wherein, when the attachment portion is positioned within the gap, the securing member is configured to receive a curable composite material over the first support, the second support, the gap, and the attachment portion, thereby securing the attachment portion within the gap.

2. The securing member of claim 1, wherein no portion of the bracket extends over the attachment portion when the attachment portion is positioned within the gap.

3. The securing member of claim 1, further comprising a backing having a first side configured to be positioned against a surface of the patient's tooth and a second side opposite the first side and configured to face away from the patient's tooth, wherein the first and second supports are attached to and extend away from the backing such that the backing is positioned between the first and second supports and the surface of the tooth when the securing member is secured to the tooth.

4. The securing member of claim 3, wherein the backing spans the gap between the first and second supports such that, when the attachment portion is secured to the securing member, the backing is positioned between the attachment portion and the surface of the tooth.

5. The securing member of claim 1, wherein the gap is configured to receive a wire therein.

6. The securing member of claim 1, wherein the gap has a shape that mimics a shape of the attachment portion configured to be received within the gap.

7. The securing member of claim 1, wherein the gap is generally U-shaped, and wherein, when the securing member is secured to the tooth, an open end of the U-shape is occlusal to a closed end of the U-shape.

8. The securing member of claim 1, wherein the gap is configured to receive a bent wire therein.

9. The securing member of claim 8, wherein the second support is configured to abut a portion of the bent wire that is concave in an occlusal direction when the attachment portion is positioned within the gap.

10. The securing member of claim 8, wherein the first support is configured to abut a portion of the bent wire that is convex in a gingival direction when the attachment portion is positioned within the gap.

11. The securing member of claim 1, wherein the gingivally-facing surface of the second support is curved and, at least when the securing member is secured to the tooth, is convex in a gingival direction.

12. The securing member of claim 1, wherein the occlusally-facing surface of the first support is curved and, at least when the securing member is secured to the tooth, is convex in a gingival direction.

13. The securing member of claim 1, wherein a width of the gap is slightly greater than a width of the attachment portion.

14. A securing member for securing an attachment portion of an orthodontic appliance to a tooth of a patient, the securing member comprising:
a first support configured to extend away from the tooth when the securing member is secured to the tooth, wherein the first support has a gingivally-facing surface configured to abut an occlusally-facing surface of the attachment portion and thereby inhibit occlusal movement of the attachment portion; and
a second support configured to extend away from the tooth when the securing member is secured to the tooth, wherein the second support is spaced apart from the first support by a gap when the securing member is secured to the tooth, the gap configured to receive the attachment portion therein, and wherein the second support has:
a mesially-facing surface configured to abut a distally-facing surface of the attachment portion and thereby inhibit distal movement of the attachment portion,
a distally-facing surface configured to abut a mesially-facing surface of the attachment portion and thereby inhibit mesial movement of the attachment portion, and
an occlusally-facing surface configured to abut a gingivally-facing surface of a corresponding attachment portion and thereby inhibit gingival movement of the attachment portion.

15. The securing member of claim 14, wherein no portion of the bracket extends over the attachment portion when the attachment portion is positioned in the gap.

16. The securing member of claim 14, further comprising a backing having a first side configured to be positioned against a surface of the patient's tooth and a second side opposite the first side and configured to face away from the patient's tooth, wherein the first and second supports are attached to and extend away from the backing such that the backing is positioned between the first and second supports and the surface of the tooth when the securing member is secured to the tooth.

17. The securing member of claim 16, wherein the backing spans the gap between the first and second supports such that, when the attachment portion is secured to the securing member, the backing is positioned between the attachment portion and the surface of the tooth.

18. The securing member of claim 14, wherein the gap is configured to receive a wire therein.

19. The securing member of claim 14, wherein the gap has a shape that mimics a shape of the attachment portion configured to be received within the gap.

20. The securing member of claim 14, wherein the gap is generally U-shaped, and wherein, when the securing member is secured to the tooth, an open end of the U-shape is gingival to a closed end of the U-shape.

21. The securing member of claim 14, wherein the gap is configured to receive a bent wire therein.

22. The securing member of claim 21, wherein the second support is configured to abut a portion of the bent wire that is concave in a gingival direction when the attachment portion is positioned within the gap.

23. The securing member of claim 21, wherein the first support is configured to abut a portion of the bent wire that is concave in a gingival direction when the attachment portion is positioned within the gap.

24. The securing member of claim 14, wherein the occlusally-facing surface of the second support is curved and, at least when the securing member is secured to the tooth, is convex in an occlusal direction.

25. The securing member of claim 14, wherein the gingivally-facing surface of the first support is curved and, at least when the securing member is secured to the tooth, is concave in a gingival direction.

26. The securing member of claim 14, wherein a width of the gap is slightly greater than a width of the attachment portion.
